(19) United States
(12) Patent Application Publication
(10) Pub. No.: US 2016/0175650 A1
(43) Pub. Date: Jun. 23, 2016

(54) INCLINATION DETERMINATION DEVICE, INCLINATION DETERMINATION SYSTEM, INCLINATION DETERMINATION METHOD, EXERCISE ANALYSIS DEVICE, EXERCISE ANALYSIS SYSTEM, EXERCISE ANALYSIS METHOD, AND RECORDING MEDIUM

(71) Applicant: SEIKO EPSON CORPORATION, Tokyo (JP)

(72) Inventors: Masafumi SATO, Hara-mura (JP); Kazuhiro SHIBUYA, Shiojiri-shi (JP)

(73) Assignee: SEIKO EPSON CORPORATION, Tokyo (JP)

(21) Appl. No.: 14/965,375

(22) Filed: Dec. 10, 2015

(30) Foreign Application Priority Data
Dec. 19, 2014 (JP) 2014-257258
Dec. 22, 2014 (JP) 2014-258824

(51) Int. Cl. A63B 24/00; G01P 15/02; G01P 3/00; G01P 13/00

(52) U.S. Cl. CPC A63B 24/0006; G01P 13/00; G01P 15/02; G01P 3/00; A63B 2024/0012

(57) ABSTRACT

An inclination determination device includes: an inclination calculation unit that calculates an inclination of an exercise tool before exercise start using an output signal of an inertial sensor; and a determination unit that determines whether the inclination of the exercise tool is included within a criterion range decided based on information regarding the exercise tool and body information regarding a user.

### BACKGROUND

1. Technical Field

The present invention relates to an inclination determination device, an inclination determination system, an inclination determination method, an exercise analysis device, an exercise analysis system, an exercise analysis method, and a recording medium.

2. Related Art

JP-A-2009-20897 discloses a method of photographing a golf swing exercise from the rear side of a user with a camera or the like, specifying a swing plane from a photographed image, displaying the swing plane and of measuring the area of the swing plane and displaying the area of the swing plane. The swing plane is a plane on which a line segment formed by an arm, a club shaft, and a club head (or a club shaft and a club head) moves and remains as a trajectory during a golf swing exercise. In general, a swing in which a swing plane does not have an area as much as possible and is close to a line segment when viewed from the rear side of a swing is regarded as a good swing. Accordingly, according to the method of the JP-A-2009-20897, the user can quantitatively know goodness and badness of a swing from information regarding the area of the swing plane.

JP-A-2010-82430 discloses that an image is acquired by performing photographing from the rear side in a hitting direction between an address state and the end of a swing and the image is split into at least three regions by a first straight line passing through a shaft axis of a golf club in the address state and a second straight line intersecting the first straight line and passing through the root of an installed tee and the base of the neck of a golfer.

In coaching of a golf swing, indexes such as a shaft plane and a Hogan's plane are used in many cases. The shaft plane is a plane that is formed by the major axis direction of a shaft of a golf club and a target line (for example, a hitting target direction) at the time of golf address. The Hogan's plane is a plane that is formed by a target line and an imaginary line connecting a periphery of a shoulder (a shoulder, the base of a neck, or the like) of a golfer to the head (or a ball) of a golf club at the time of the golf address. A region interposed between the shaft plane and the Hogan's plane is called a V zone. When a trajectory of a golf club enters the V zone, for example, at the time of downswing, straight-based hitting is known to be realized. Accordingly, goodness and badness of a swing can be evaluated according to whether a trajectory of a golf club enters the V zone, for example, at the time of downswing.

However, even when the area of a swing plane is small, hook-based or slice-based hitting can be realized according to a trajectory of a swing. Thus, a good swing may not necessarily be performed. Accordingly, in coaching of a golf swing, indexes such as a shaft plane and a Hogan's plane are used in some cases.

To specify a V zone, it is necessary to obtain the inclination of the shaft of a golf club at the time of an address posture. However, in the method of the related art, the inclination of a shaft is obtained when a user does not take an address posture before exercise start in some cases. In this case, since the inclination of the shaft is not in an appropriate range, there is a possibility of an impossible V zone being generated. Thus, when it may not be determined whether the inclination of the shaft is in the appropriate range before the exercise start, for example, various other problems such as erroneous permission of exercise start to a user can occur. Further, such problems can occur in various exercises as well as golf swings.

A method of simply presenting a shaft plane and a Hogan's plane to a user has not been proposed until now. For example, in JP-A-2010-82430, a V zone is specified by photographing a golfer in an address state with a camera and drawing a straight line in an image based on an instruction input from a user. In JP-A-2010-82430, there are problems in that, for example, it is difficult to install a camera so that the whole body of a golfer is contained in an image, it is difficult to visually confirm the V zone on an image (it is difficult for a user to decide a position at which a straight line is drawn), and it is difficult to visually confirm whether a trajectory of a golf club in a downswing is included in the V zone.

### SUMMARY

The invention can be implemented as the following aspects or application examples. For example, an advantage of some aspects of the invention is to provide an inclination determination device, an inclination determination system, an inclination determination method, and a program capable of determining whether the inclination of an exercise tool before exercise start is included in an appropriate range. Another advantage of some aspects of the invention is to support estimation of goodness or badness of a swing more simply than in the related art.

### APPLICATION EXAMPLE1

An inclination determination device according to this application example includes: an inclination calculation unit that calculates an inclination of an exercise tool before exercise start using an output signal of an inertial sensor; and a determination unit that determines whether the inclination of the exercise tool is included within a criterion range decided based on information regarding the exercise tool and body information regarding a user.

The inertial sensor may be a sensor that can measure inertial amounts of an acceleration or an angular velocity. For example, the inertial sensor may be an inertial measurement unit (IMU) capable of measuring an acceleration and an angular velocity. For example, the inertial sensor may be fitted on a portion of an exercise tool or a user or may be detachably mounted on an exercise tool or a user. For example, the inertial sensor may be built in an exercise tool to be fixed to the exercise tool so that the sensor is not detachable.

The exercise tool may be a tool used for various exercises and may be, for example, a tool used for a swing of a golf club, a tennis racket, a baseball bat, or a hockey stick. The inclination calculation unit may directly calculate the inclination of the exercise tool before the exercise start and may indirectly calculate the inclination of the exercise tool by calculating information (for example, an inclination of a detection axis of the inertial sensor or a posture angle of the inertial sensor when a relative position or posture to the exercise tool is known) capable of specifying the inclination of the exercise tool. The determination unit may directly determine whether the inclination of the exercise tool is included in the criterion range or may indirectly determine whether the inclination of the exercise tool is included in the criterion range by determining whether the information capable of specifying the inclination of the exercise tool is included in a desired range corresponding to the criterion range of the inclination of the exercise tool.

In this application example, the inclination determination device determines whether the inclination of the exercise tool before the exercise start is included in the criterion range decided based on the information regarding the exercise tool and the body information regarding the user, focusing on the fact that an appropriate range of the inclination of the exercise tool is decided according to the exercise tool or the body of the user, when the user takes an appropriate basic posture before exercise start. Accordingly, in the inclination determination device according to the application example, it is possible to determine whether the inclination of the exercise tool before the exercise start of the user is included in the appropriate range.

### APPLICATION EXAMPLE2

In the inclination determination device according to the application example, the body information may include at least one piece of information regarding a height, a length of an arm, and a length of a leg.

In the inclination determination device according to this application example, it is possible to determine whether the inclination of the exercise tool before the exercise start of the user is included in the appropriate range in which the shape of the user is considered.

### APPLICATION EXAMPLE3

In the inclination determination device according to the application example, the body information may further include information regarding sex.

In the inclination determination device according to this application example, it is possible to determine whether the inclination of the exercise tool before the exercise start of the user is included in the appropriate range in which not only the shape of the user but also the sex are considered.

### APPLICATION EXAMPLE4

In the inclination determination device according to the application example, the information regarding the exercise tool may be at least one of information regarding a length of the exercise tool and information regarding a type of the exercise tool.

In the inclination determination device according to this application example, it is possible to determine whether the inclination of the exercise tool before the exercise start of the user is included in the appropriate range in which the length of the exercise tool or the type of exercise tool is considered.

### APPLICATION EXAMPLE5

The inclination determination device according to the application example may further include a notification unit that notifies the user of exercise start permission when the determination unit determines that an inclination of the exercise tool is included in the criterion range.

In the inclination determination device according to this application example, it is possible to determine whether the user takes an appropriate basic posture before the exercise start.

### APPLICATION EXAMPLE6

The inclination determination device according to the application example may further include a first specifying unit that specifies a first axis which lies in a major axis direction of the exercise tool using the output signal of the inertial sensor when the determination unit determines that the inclination of the exercise tool is included in the criterion range.

In the inclination determination device according to this application example, the major axis direction of the exercise tool can be specified when the user can take the appropriate basic posture before the exercise start.

### APPLICATION EXAMPLE7

In the inclination determination device according to the application example, the first specifying unit may specify the first axis using the output signal of the inertial sensor when the inclination of the exercise tool is included in the criterion range.

### APPLICATION EXAMPLE8

The inclination determination device according to the application example may further include a second specifying unit that specifies a second axis which connects a blow position to a predetermined position between a head of the user to a chest of the user, using the output signal of the inertial sensor when the determination unit determines that the inclination of the exercise tool is included in the criterion range.

In the inclination determination device according to this application example, the predetermined position may be estimated using the output signal of the inertial sensor and the body information.

In the inclination determination device according to this application example, it is possible to specify the second axis connecting the blow position to the predetermined position between the head and the chest when the user can take the appropriate basic posture before the exercise start.

### APPLICATION EXAMPLE9

In the inclination determination device according to the application example, the second specifying unit may specify the second axis using the output signal of the inertial sensor when the inclination of the exercise tool is included in the criterion range.

### APPLICATION EXAMPLE10

An inclination determination system according to this application example includes the inclination determination device according to the application example; and an inertial sensor.

### APPLICATION EXAMPLE11

An inclination determination method according to this application example includes: calculating an inclination of an exercise tool before exercise start using an output signal of an inertial sensor; and determining whether the inclination of the exercise tool is included within a criterion range decided based on information regarding the exercise tool and body information regarding a user.

In the inclination determination method of this application example, it is possible to determine whether the inclination of the exercise tool before the exercise start is included in the criterion range decided based on the information regarding the exercise tool and the body information regarding the user, focusing on the fact that an appropriate range of the inclination of the exercise tool is decided according to the exercise tool or the body of the user, when the user takes an appropriate basic posture before exercise start. Accordingly, in this case, it is possible to determine whether the inclination of the exercise tool before the exercise start of the user is included in the appropriate range.

### APPLICATION EXAMPLE12

A recording medium according to this application example records a program causing a computer to perform: calculating an inclination of an exercise tool before exercise start using an output signal of an inertial sensor; and determining whether the inclination of the exercise tool is included within a criterion range decided based on information regarding the exercise tool and body information regarding a user.

In this application example, the recording medium records the program causing the computer to determine whether the inclination of the exercise tool before the exercise start is included in the criterion range decided based on the information regarding the exercise tool and the body information regarding the user, focusing on the fact that an appropriate range of the inclination of the exercise tool is decided according to the exercise tool or the body of the user, when the user takes an appropriate basic posture before exercise start. Accordingly, in this case, the computer can be caused to determine whether the inclination of the exercise tool before the exercise start of the user is included in the appropriate range.

### APPLICATION EXAMPLE13

An exercise analysis device according to this application example includes: a first specifying unit that specifies a first axis which lies in a major axis direction of a shaft of an exercise tool at an address posture of a user, using an output of an inertial sensor; a second specifying unit that specifies a second axis forming a predetermined angle with the first axis when a hitting direction is set as a rotation axis; and an adjustment unit that adjusts an angle of the second axis when the angle of the second axis is greater than a threshold angle.

With this configuration, the user can objectively recognize the address posture based on the positions and inclinations of the first and second axes and the size of the space between the first and second axes and recognize the positional relation between the assumed trajectory of the swing and the first and second axes, and therefore it is possible to simply evaluate the swing. It is possible to appropriately adjust the position and the inclination of the angle of the second axis greater than the threshold angle (for example, 90°) which may not generally be assumed, and it is possible to prevent discomfort of the user.

### APPLICATION EXAMPLE14

In the exercise analysis device according to the application example, the adjustment unit may set the angle of the second axis to an angle which is equal to or less than the threshold angle and is greater than the angle of the first axis.

### APPLICATION EXAMPLE15

In the exercise analysis device according to the application example, the adjustment unit may set the angle of the second axis to the threshold angle.

### APPLICATION EXAMPLE16

In the exercise analysis device according to the application example, the adjustment unit may set the angle of the second axis to be less than the threshold angle.

In this application example, the angle of the second axis greater than the threshold angle (for example, 90°) which may not generally be assumed and an area between the first and second axes can be flexibly set according to a type of swing of the user, a habit of a swing, the specification of a club to be used, and the like.

### APPLICATION EXAMPLE17

In the exercise analysis device according to the application example, the adjustment unit may rotate the angle of the first axis an opposite side to the second axis when the angle of the second axis is greater than the threshold angle.

With this configuration, the angle of the second axis greater than the threshold angle (for example, 90°) which may not generally be assumed can be appropriately adjusted without narrowing the area between the first and second axes as much as possible.

### APPLICATION EXAMPLE18

In the exercise analysis device according to the application example, the adjustment unit may set the angles of the first and second axes without changing an angle difference between the first and second axes.

### APPLICATION EXAMPLE19

In the exercise analysis device according to the application example, the adjustment unit may set the angle of the second axis to the threshold angle.

### APPLICATION EXAMPLE20

In the exercise analysis device according to the application example, the adjustment unit may set the angle of the second axis to be less than the threshold angle.

In this application example, the angle of the second axis greater than the threshold angle (for example, 90°) which may not generally be assumed and the inclination degree of the space between the first and second axes can be flexibly set according to a type of swing of the user, a habit of a swing, the specification of a club to be used, and the like.

### APPLICATION EXAMPLE21

In the exercise analysis device according to the application example, the first specifying unit may calculate an inclination angle of the shaft with respect to a horizontal plane using the output of the inertial sensor at the address posture of the user and specify the first axis using the inclination angle and information regarding a length of the shaft.

With this configuration, at the time of stopping of the user, it is possible to calculate an inclination angle of the shaft of the exercise tool using the fact that the inertial sensor detects only the gravity acceleration, and it is possible to specify the direction of the first axis from the inclination angle.

### APPLICATION EXAMPLE22

In the exercise analysis device according to the application example, when the hitting direction is set as a third axis, the first specifying unit may specify a first imaginary plane including the first and third axes and the second specifying unit may specify a second imaginary plane including the second and third axes.

With this configuration, the user can objectively recognize the address posture based on the positions and the inclinations of the first and second imaginary planes and the size of the space between the first and second imaginary planes and can recognize the positional relation between the assumed trajectory of the swing and the first and second imaginary planes, and therefore the user can simply evaluate the swing.

### APPLICATION EXAMPLE23

In the exercise analysis device according to the application example, the exercise tool may include a blow surface. The hitting direction may be a direction perpendicular to the blow surface at the address posture of the user.

With this configuration, by assuming that the user stops at the posture at which the hitting direction is perpendicular to the blow surface of the exercise tool, it is possible to specify the hitting direction using the output of the inertial sensor.

### APPLICATION EXAMPLE24

The exercise analysis device according to the application example may further include an image generation unit that generates image data including the first and second axes. With this configuration, the user can objectively and easily recognize the posture at the time of the stop based on the positions and the inclinations of the first and second axes and the size of the space between the first and second axes and can recognize the positional relation between the assumed trajectory of the swing and the first and second axes from the image, and therefore, it is possible to objectively and simply evaluate the swing.

### APPLICATION EXAMPLE25

The exercise analysis device according to the application example may further include an exercise analysis unit that calculates a trajectory of the exercise tool based on a swing of the user. The image generation unit may generate the image data including the first axis, the second axis, and the trajectory.

With this configuration, the user can determine whether the trajectory of the swing is included between the first and second axes from the image, and therefore it is possible to objectively and simply evaluate goodness and badness of the swing.

### APPLICATION EXAMPLE26

An exercise analysis system according to this application example includes: an inertial sensor; a first specifying unit that specifies a first axis which lies in a major axis direction of a shaft of an exercise tool at an address posture of a user, using an output of the inertial sensor; a second specifying unit that specifies a second axis forming a predetermined angle with the first axis when a hitting direction is set as a rotation axis; and an adjustment unit that adjusts an angle of the second axis when the angle of the second axis is greater than a threshold angle.

With this configuration, the user can objectively recognize the address posture based on the positions and the inclinations of the first and second axes and the size of the space between the first and second axes and can recognize the positional relation between the assumed trajectory of the swing and the first and second axes, and therefore the user can simply evaluate the swing. It is possible to appropriately adjust the position and the inclination of the angle of the second axis greater than the threshold angle (for example, 90°) which may not generally be assumed, and it is possible to prevent discomfort of the user.

### APPLICATION EXAMPLE27

An exercise analysis method according to this application example includes: specifying a first axis which lies in a major axis direction of a shaft of an exercise tool at an address posture of a user, using an output of an inertial sensor; specifying a second axis forming a predetermined angle with the first axis when a hitting direction is set as a rotation axis; and adjusting an angle of the second axis when the angle of the second axis is greater than a threshold angle.

With this configuration, the user can objectively recognize the address posture based on the positions and the inclinations of the first and second axes and the size of the space between the first and second axes and can recognize the positional relation between the assumed trajectory of the swing and the first and second axes, and therefore the user can simply evaluate the swing. It is possible to appropriately adjust the position and the inclination of the angle of the second axis greater than the threshold angle (for example, 90°) which may not generally be assumed, and it is possible to prevent discomfort of the user.

### APPLICATION EXAMPLE28

A recording medium according to this application example records a program causing a computer to perform: specifying a first axis which lies in a major axis direction of a shaft of an exercise tool at an address posture of a user, using an output of an inertial sensor; specifying a second axis forming a predetermined angle with the first axis when a hitting direction is set as a rotation axis; and adjusting an angle of the second axis when the angle of the second axis is greater than a threshold angle.

With this configuration, the user can objectively recognize the address posture based on the positions and the inclinations of the first and second axes and the size of the space between the first and second axes and can recognize the positional relation between the assumed trajectory of the swing and the first and second axes, and therefore the user can simply evaluate the swing. It is possible to appropriately adjust the position and the inclination of the angle of the second axis greater than the threshold angle (for example, 90°) which may not generally be assumed, and it is possible to prevent discomfort of the user.

### BRIEF DESCRIPTION OF THE DRAWINGS

The invention will be described with reference to the accompanying drawings, wherein like numbers reference like elements.

FIG. 1 is a diagram illustrating an overview of an inclination determination system according to a first embodiment of the invention.

FIG. 2 is a diagram illustrating examples of mounted-position and a direction of the sensor unit.

FIG. 3 is a diagram illustrating an order of a motion performed by a user according to the first embodiment.

FIG. 4A is a diagram illustrating an example of an input screen of body information.

FIG. 4B is a diagram illustrating an example of an input screen of golf club information.

FIG. 5 is a diagram illustrating a shaft plane and a Hogan's plane.

FIG. 6 is a diagram illustrating an example of the configuration of an inclination determination system according to the first embodiment.

FIG. 7 is a diagram illustrating an example of table information defining an upper limit of a criterion range of an inclination angle of a golf club at the time of address of a user.

FIG. 8 is a diagram illustrating an example of table information defining a lower limit of the criterion range of the inclination angle of the golf club at the time of address of the user.

FIG. 9 is a flowchart illustrating a procedure example of an exercise analysis process according to the first embodiment of the invention.

FIG. 10 is a flowchart illustrating a procedure example of a process of specifying a shaft plane.

FIG. 11 is a plan view illustrating the golf club and the sensor unit at the time of stopping of the user when viewed from the negative side of the X axis.

FIG. 12 is a diagram illustrating a cross section obtained by cutting the shaft plane along the YZ plane when viewed from the negative side of the X axis.

FIG. 13 is a flowchart illustrating a procedure example of a process of specifying a Hogan's plane.

FIG. 14 is a diagram illustrating a cross section obtained by cutting the Hogan's plane along the YZ plane when viewed from the negative side of the X axis.

FIG. 15 is a flowchart illustrating a procedure example of a process of detecting a timing at which the user performs hitting.

FIG. 16 is a diagram illustrating the shaft plane and the Hogan's plane when viewed from the negative side of the X axis (a diagram projected to the YZ plane).

FIG. 17 is a diagram illustrating an example of an image displayed on a display unit.

FIG. 18 is a diagram illustrating an overview of an exercise analysis system according to a second embodiment of the invention.

FIG. 19 is a block diagram illustrating an example of the configuration of the exercise analysis system.

FIG. 20 is a flowchart illustrating an example of an exercise analysis process.

FIG. 21 is a diagram illustrating a cross section obtained by cutting the Hogan's plane along the YZ plane when viewed from the negative side of the X axis.

FIG. 22A is a diagram illustrating an example when a Hogan's plane does not exceed a predetermined upper limit angle.

FIG. 22B is a diagram illustrating an example when the Hogan's plane exceeds a predetermined upper limit angle.

FIG. 23A is a diagram illustrating an example of an adjustment procedure so that the Hogan's plane does not exceed the predetermined upper limit angle.

FIG. 23B is a diagram illustrating an example of an adjustment procedure so that the Hogan's plane does not exceed the predetermined upper limit angle.

FIG. 24A is a diagram illustrating an example of an adjustment procedure so that the Hogan's plane does not exceed the predetermined upper limit angle.

FIG. 24B is a diagram illustrating an example of an adjustment procedure so that the Hogan's plane does not exceed the predetermined upper limit angle.

FIG. 25 is a diagram illustrating examples of angular velocities output from the sensor unit.

FIG. 26 is a diagram illustrating an example of a norm of an angular velocity.

FIG. 27 is a diagram illustrating an example of a differential value of the norm of an angular velocity.

FIG. 28 is a diagram illustrating the shaft plane and the Hogan's plane projected to the YZ plane (when adjustment is not necessary).

FIG. 29 is a diagram illustrating the shaft plane and the Hogan's plane projected to the YZ plane (when adjustment is performed).

### DESCRIPTION OF EXEMPLARY EMBODIMENTS

### First Embodiment

Hereinafter, preferred embodiments of the invention will be described in detail with reference to the drawings. The embodiments to be described below do not inappropriately limit content of the invention described in the appended claims. All of the constituent elements to be described below may not be said to be prerequisite constituent elements of the invention.

Hereinafter, an inclination determination system (exercise analysis system) analyzing a golf swing will be described as an example.

### 1. Inclination Determination System

### 1-1. Overview of Inclination Determination System

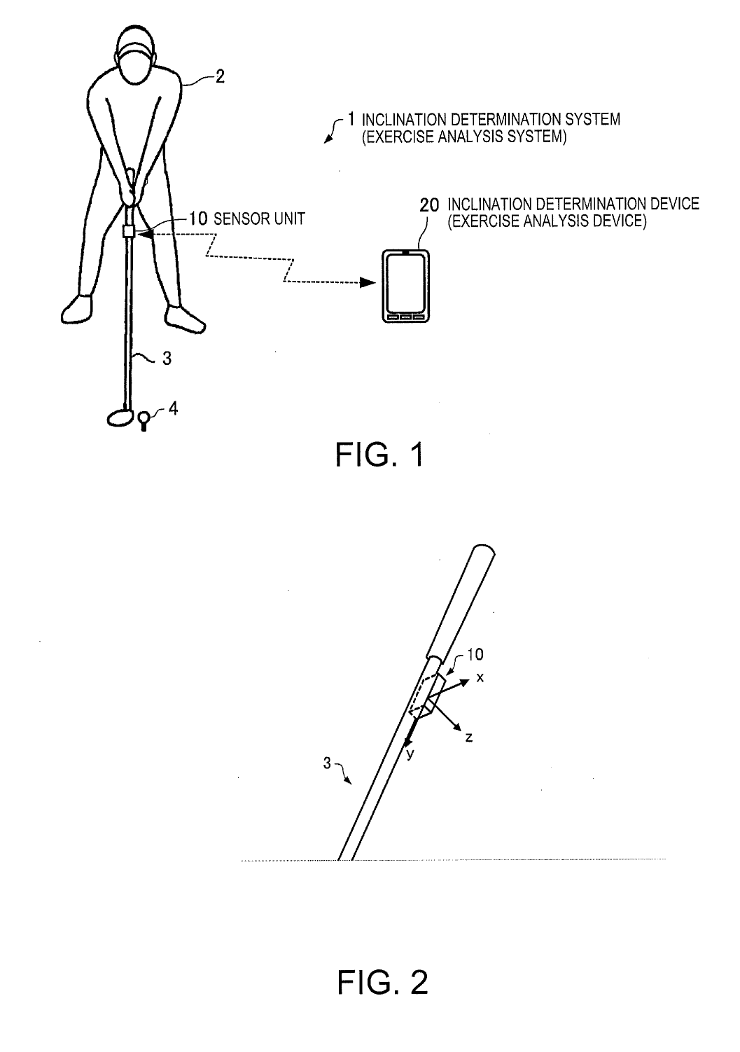

FIG. 1 is a diagram illustrating an overview of the inclination determination system according to the embodiment. An inclination determination system 1 (exercise analysis system) according to the embodiment is configured to include a sensor unit 10 (which is an example of an inertial sensor) and an inclination determination device 20 (exercise analysis device).

The sensor unit 10 can measure an acceleration generated in each axis direction of three axes and an angular velocity generated in each rotation of the three axes and is mounted on a golf club 3 (which is an example of an exercise tool).

In the embodiment, as illustrated in FIG. 2, the sensor unit 10 is fitted on a part of the shaft of the golf club 3 when one axis among three detection axes (the x axis, the y axis, and the z axis), for example, the y axis, conforms to the major axis direction of the shaft. Preferably, the sensor unit 10 is fitted at a position close to a grip in which a shock at the time of hitting is rarely delivered and a centrifugal force is not applied at the time of a swing. The shaft is a portion of the handle excluding the head of the golf club 3 and also includes the grip. However, the sensor unit 10 may be fitted to a portion (for example, a hand or a glove) of a user 2 or may be fitted in an accessory such as a wristwatch.

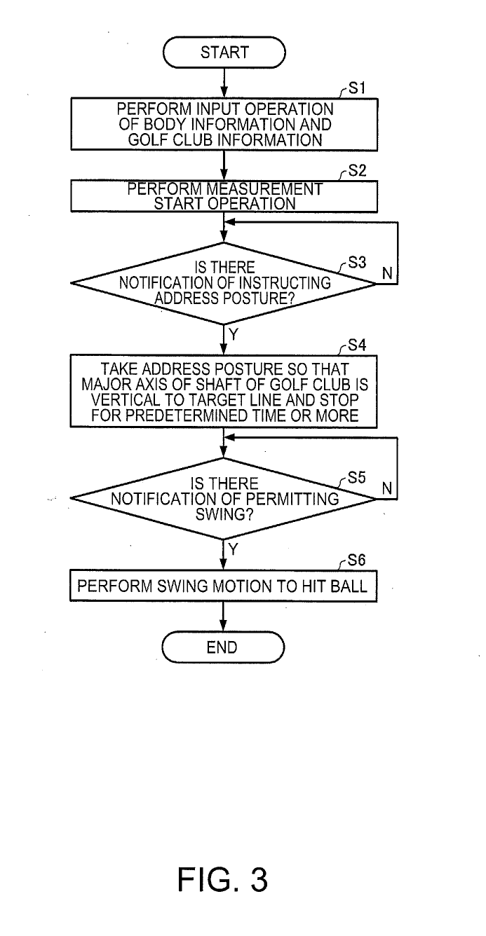

The user 2 performs a swing motion of hitting a golf ball 4 in a pre-decided procedure. FIG. 3 is a diagram illustrating an order of a motion performed by the user 2 according to the embodiment. As illustrated in FIG. 3, the user 2 performs an input operation of body information regarding the user 2 and information regarding the golf club 3 (golf club information) used by the user 2 through the inclination determination device 20 (S1). The body information includes at least one piece of information regarding the height, the lengths of the arms, and lengths of the legs of the user 2 and may include sex information or other information. The golf club information includes at least one of information regarding the length (club length) of the golf club 3 and a type (model number) of golf club 3. Next, the user 2 performs a measurement start operation (an operation of causing the sensor unit 10 to start measurement) through the inclination determination device 20 (S2). Next, after the user 2 receives a notification (for example, a notification through a sound) of instructing the user 2 to take an address posture (basic posture before exercise start) from the inclination determination device 20 (Y of S3), the user 2 takes the address posture so that the major axis of the shaft of the golf club 3 is vertical to a target line (hitting target direction) and stops (S4). Next, the user 2 performs a swing motion after receiving a notification (for example, a notification through a sound) of permitting a swing from the inclination determination device 20 (Y of S5) and hits the golf ball 4 (S6).

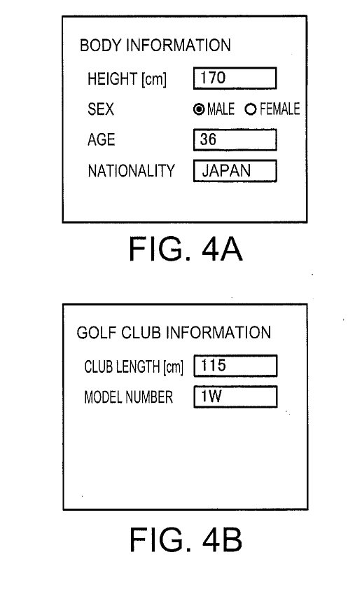

FIG. 4A is a diagram illustrating an example of an input screen of the body information displayed on a display unit of the inclination determination device 20. FIG. 4B is a diagram illustrating an example of an input screen of the golf club information displayed on the display unit of the inclination determination device 20. In S1 of FIG. 3, the user 2 inputs the body information such as height, sex, age, and nationality on the input screen illustrated in FIG. 4A and inputs the golf club information such as a club length and a model number on the input screen illustrated in FIG. 4B. The information included in the body information is not limited thereto. For example, the body information may include at least one piece of information regarding the lengths of the arms and the lengths of the legs instead of the height or along with the height. Similarly, the information included in the golf club information is not limited thereto. For example, the golf club information may not include at least one piece of information regarding the club length and the model number or may include another piece of information.

When the user 2 performs the measurement start operation of S2 of FIG. 3, the sensor unit 10 measures triaxial accelerations and triaxial angular velocities at a predetermined period (for example, 1 ms) and sequentially transmits the measured data to the inclination determination device 20. Communication between the sensor unit 10 and the inclination determination device 20 may be wireless communication or wired communication.

The inclination determination device 20 calculates an inclination of the golf club 3 before exercise start of the user 2 using the data (which is an example of an output signal of the inertial sensor) measured by the sensor unit 10 and determines whether the inclination of the exercise tool is included in a criterion range decided based on the golf club information and the body information input in S1 of FIG. 3. When the inclination determination device 20 determines that the inclination of the golf club 3 before the exercise start is included in the criterion range, the user 2 is notified of the swing start permission (which is an example of permission to start an exercise) described in S5 of FIG. 3. Thereafter, the inclination determination device 20 analyzes the swing motion in which the user 2 performs hitting using the golf club 3. For example, the inclination determination device 20 generates trajectory information of the head or the grip end of the golf club 3 in the swing using measurement data measured by the sensor unit 10.

In particular, in the embodiment, when the inclination determination device 20 determines that the inclination of the golf club 3 before the exercise start of the user 2 is included in the criterion range, the inclination determination device 20 specifies a first axis which lies in the major axis direction of the golf club 3, using measurement data of the sensor unit 10 when the inclination of the golf club 3 is included in the criterion range, and specifies a shaft plane which is a first imaginary plane at the time of stopping of the user 2 (at the time of address) based on the first axis. When the inclination determination device 20 determines that the inclination of the golf club 3 before the exercise start of the user 2 is included in the criterion range, the inclination determination device 20 specifies a second axis connecting a blow position to a predetermined position between the head and the chest of the user 2, using measurement data of the sensor unit 10 when the inclination of the golf club 3 is included in the criterion range, and specifies a Hogan's plane which is a second imaginary plane at the time of stopping of the user 2 (at the time of address) based on the two axes. Then, the inclination determination device 20 determines whether a trajectory of the golf club 3 from the swing start to the time of hitting of the user 2 is included in a space called a V zone between the shaft plane and the Hogan's plane. The inclination determination device 20 generates image data including the trajectory of the golf club 3, the shaft plane, and the Hogan's plane in the swing of the user 2 and causes the display unit (display) to display an image according to the image data. The inclination determination device 20 may be, for example, a portable device such as a smartphone or a personal computer (PC).

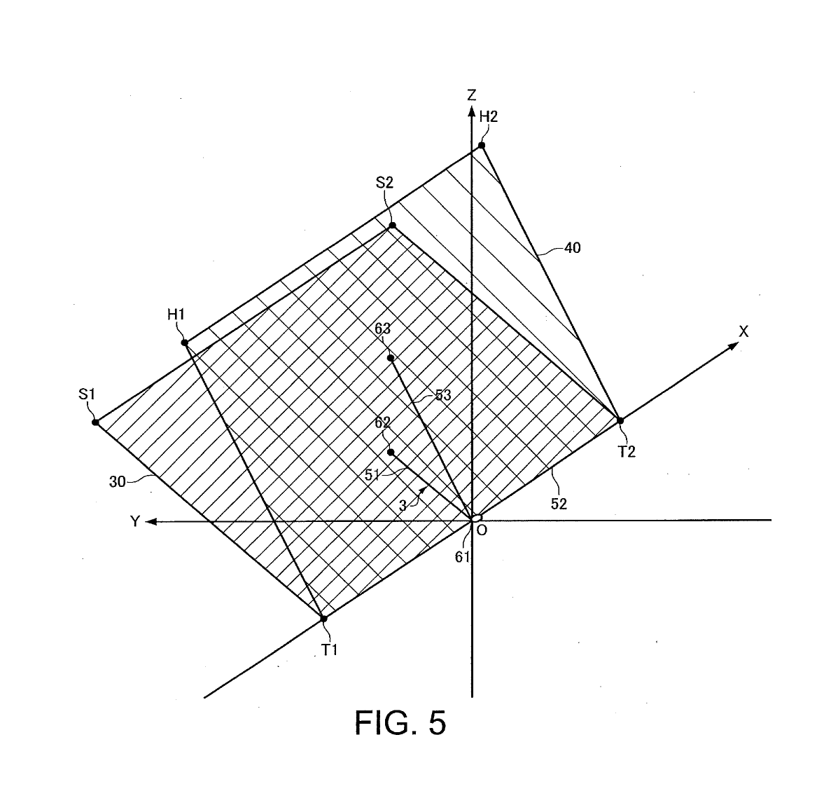

FIG. 5 is a diagram illustrating a shaft plane and a Hogan's plane at the time of address of the user 2 according to the embodiment. In the embodiment, an XYZ coordinate system (global coordinate system) in which a target line indicating a hitting target direction is an X axis, an axis on a horizontal plane vertical to the X axis is a Y axis, and an upward vertical direction (which is an opposite direction to the direction of the gravity acceleration) is a Z axis is defined. In FIG. 5, the X, Y, and Z axes are shown. In the embodiment, as illustrated in FIG. 5, a shaft plane 30 at the time of address of the user 2 is an imaginary plane which includes a first line segment 51 serving as the first axis which lies in the major axis direction of the shaft of the golf club 3 and a third line segment 52 serving as a third axis indicating a hitting target direction and has four vertexes T1, T2, S1, and S2. In the embodiment, a position 61 of the head (blow portion) of the golf club 3 is set as the origin O (0, 0, 0) of the XYZ coordinate system. The first line segment 51 is a line segment which connects the position 61 (the origin O) of the head of the golf club 3 to a position 62 of the grip end. The third line segment 52 is a line segment which has T1 and T2 on the X axis as both ends, has a length TL, and centers on the origin O. When the user 2 performs the motion of S4 of FIG. 3 at the time of the address, the shaft of the golf club 3 is vertical to the target line (the X axis). Therefore, the third line segment 52 is a line segment which is perpendicular to the major axis direction of the shaft of the golf club 3, that is, a line segment perpendicular to the first line segment 51. The shaft plane 30 is specified by calculating the coordinates of the four vertexes T1, T2, S1, and S2 in the XYZ coordinate system. A method of calculating the coordinates of the four vertexes T1, T2, S1, and S2 will be described in detail below.

In the embodiment, as described in FIG. 5, the Hogan's plane 40 is an imaginary plane which includes the third line segment 52 and a second line segment 53 serving as the second axis and has four vertexes T1, T2, H1, and H2. In the embodiment, the second line segment 53 is a line segment which connects a position 61 (which is an example of a blow position) of the head (blow portion) of the golf club 3 to a predetermined position 63 (which is, for example, the position of the base of the neck or the position of one of the right and left shoulders) on a line segment connecting both shoulders of the user 2 to one another. Here, the second line segment 53 may be, for example, a line segment which connects the predetermined position 63 to the position (which is an example of the blow position) of the golf ball 4. The Hogan's plane 40 is specified by calculating the coordinates of the four vertexes T1, T2, H1, and H2 in the XYZ coordinate system. A method of calculating the coordinates of the four vertexes T1, T2, H1, and H2 will be described in detail below.

### 1-2. Configuration of Inclination Determination System

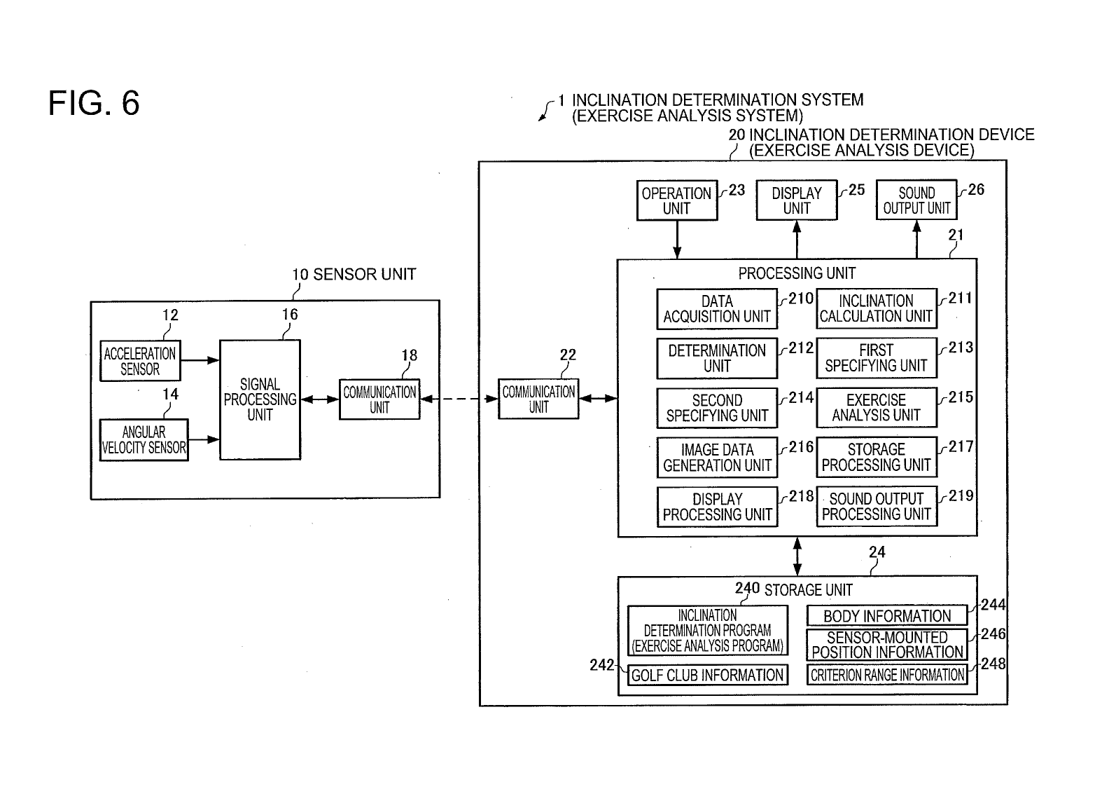

FIG. 6 is a diagram illustrating an example of the configuration (examples of the configurations of the sensor unit 10 and the inclination determination device 20) of an inclination determination system 1 according to the embodiment. In the embodiment, as illustrated in FIG. 6, the sensor unit 10 is configured to include an acceleration sensor 12, an angular velocity sensor 14, a signal processing unit 16, and a communication unit 18.

The acceleration sensor 12 (which is an example of an inertial sensor) measures acceleration generated in each of mutually intersecting triaxial directions (ideally, orthogonal to each other) and outputs digital signals (acceleration data) according to the magnitudes and directions of the measured triaxial accelerations.

The angular velocity sensor 14 (which is an example of an inertial sensor) measures an angular velocity generated at axis rotation of mutually intersecting triaxial directions (ideally, orthogonal to each other) and outputs digital signals (angular velocity data) according to the magnitudes and directions of the measured triaxial angular velocities. The signal processing unit 16 receives the acceleration data and the angular velocity data from the acceleration sensor 12 and the angular velocity sensor 14, appends time information, and stores the acceleration data and the angular velocity data in a storage unit (not illustrated). The signal processing unit 16 generates packet data in conformity to a communication format by appending time information to the stored measurement data (the acceleration data and the angular velocity data) and outputs the packet data to the communication unit 18.

The acceleration sensor 12 and the angular velocity sensor 14 are ideally fitted in the sensor unit 10 so that the three axes of each sensor match the three axes (the x axis, the y axis, and the z axis) of the rectangular coordinate system (sensor coordinate system) defined for the sensor unit 10, but errors of the fitting angles actually occur. Accordingly, the signal processing unit 16 performs a process of converting the acceleration data and the angular velocity data into data of the xyz coordinate system, using correction parameters calculated in advance according to the errors of the fitting angles.

The signal processing unit 16 may perform a temperature correction process of the acceleration sensor 12 and the angular velocity sensor 14. Alternatively, a temperature correction function may be embedded in the acceleration sensor 12 and the angular velocity sensor 14.

The acceleration sensor 12 and the angular velocity sensor 14 may output analog signals. In this case, the signal processing unit 16 may perform A/D (analog/digital) conversion on each of an output signal of the acceleration sensor 12 and an output signal of the angular velocity sensor 14, generate measurement data (acceleration data and angular velocity data), and generate packet data for communication using the measurement data.

The communication unit 18 performs, for example, a process of transmitting the packet data received from the signal processing unit 16 to the inclination determination device 20 or a process of receiving control commands from the inclination determination device 20 and transmitting the control commands to the signal processing unit 16. The signal processing unit 16 performs various processes according to the control commands.

The inclination determination device 20 (exercise analysis device) includes a processing unit 21, a communication unit 22, an operation unit 23, a storage unit 24, a display unit 25, and a sound output unit 26.

The communication unit 22 performs, for example, a process of receiving the packet data transmitted from the sensor unit 10 and transmitting the packet data to the processing unit 21 or a process of transmitting a control command from the processing unit 21 to the sensor unit 10.

The operation unit 23 performs a process of acquiring operation data from the user 2 and transmitting the operation data to the processing unit 21. The operation unit 23 may be, for example, a touch panel type display, a button, a key, or a microphone.

The storage unit 24 is configured as, for example, any of various IC memories such as a read-only memory (ROM), a flash ROM, and a random access memory (RAM) or a recording medium such as a hard disk or a memory card.

The storage unit 24 stores, for example, programs used for the processing unit 21 to perform various calculation processes or control processes, or various programs or data used for the processing unit 21 to realize application functions. In particular, in the embodiment, the storage unit 24 stores an inclination determination program 240 (exercise analysis program) which is read by the processing unit 21 to perform an inclination determination process (exercise analysis process). The inclination determination program 240 may be stored in advance in a nonvolatile recording medium. Alternatively, the inclination determination program 240 may be received from a server via a network by the processing unit 21 and may be stored in the storage unit 24.

In the embodiment, the storage unit 24 stores golf club information 242, body information 244, sensor-mounted position information 246, and criterion range information 248. For example, when the user 2 operates the operation unit 23 to input golf club information regarding the golf club 3 to be used from the input screen in FIG. 4B, and the input golf club information may be set as the golf club information 242. Alternatively, in S1 of FIG. 3, the user 2 may input a model number of the golf club 3 (or select the model number from a model number list) and set specification information of the input model number as the golf club information 242 among pieces of specification information for each model number (for example, information regarding the length of the shaft, the position of the center of gravity, a lie angle, a face angle, a loft angle, and the like) stored in advance in the storage unit 24. For example, the user 2 may operate the operation unit 23 to input body information from the input screen in FIG. 4A and set the input body information as the body information 244. For example, in S1 of FIG. 3, the user 2 may operate the operation unit 23 to input a distance between the position at which the sensor unit 10 is mounted and the grip end of the golf club 3 and set information regarding the input distance as the sensor-mounted position information 246. Alternatively, by mounting the sensor unit 10 at a decided predetermined position (for example, a distance of 20 cm from the grip end), information regarding the predetermined position may be stored in advance as the sensor-mounted position information 246.

The criterion range information 248 is information that defines a range (criterion range) appropriate as an inclination angle (an inclination with respect to the horizontal plane (XY plane) or the vertical plane (XZ plane)) of the golf club at the time of address of the user. For example, the criterion range information 248 may include table information that defines each criterion range according to a combination of the height of the user and the club length (the length of the shaft) of the golf club used by the user.

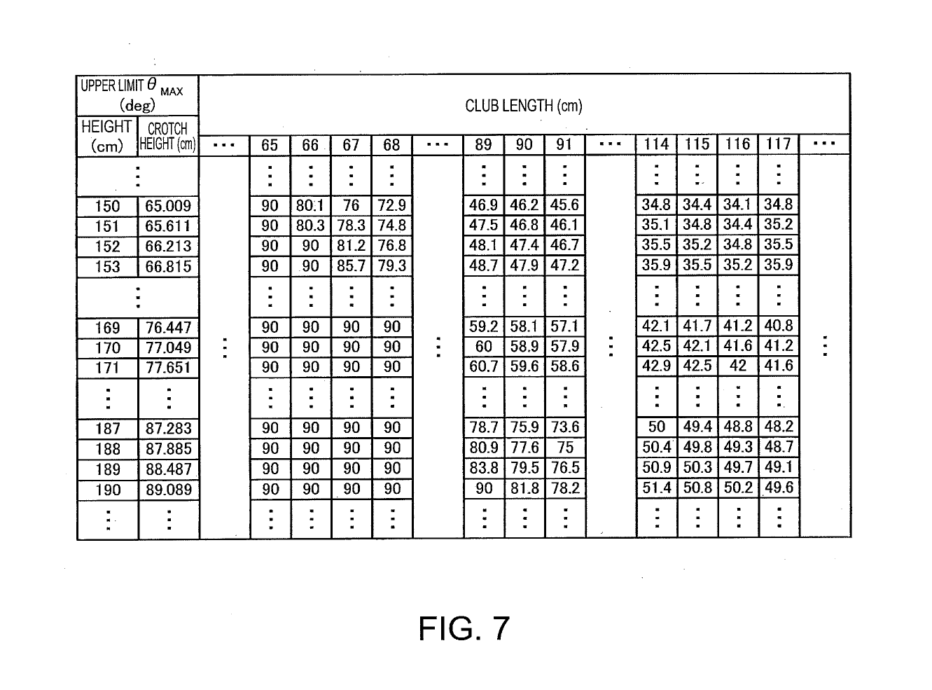

FIG. 7 is a diagram illustrating an example of table information (lookup table) that defines an upper limit θMAX of the criterion range of an inclination angle θ (an inclination with respect to the horizontal plane (XY plane)) of the golf club at the time of address of the user included in the criterion range information 248. In FIG. 7, heights or crotch height (crotch length) (unit: cm) are arranged in the column direction and club lengths (unit: cm) are arranged in the row direction. In the embodiment, the inclination angle θ when a height of the grip end of the golf club from the ground is nearly identical to the crotch height (substantial length of a leg) is assumed to be the upper limit θMAX. The crotch height is calculated by a correlation equation based on statistical data using the height as variables (more specifically, using sex, age, nationality, and the like as variables). When a is the club length and b is the crotch height, the upper limit θMAX is calculated by arcsin(b/a). In the lookup table of FIG. 7, for example, as illustrated in FIG. 4A, the crotch height is calculated as 77.049 cm for the user 2 of which the height is 170 cm (male, 36 year old, and Japanese). As illustrated in FIG. 4B, when the golf club 3 with a club length of 115 cm is used, the upper limit θMAX is defined as 42.1°. Since an address posture at which the club length a is less than the crotch height b (the upper limit θMAX exceeds 90°) may not be considered, the upper limit θMAX in a combination in which the club length a is less than the crotch height b is set to 90° in the example of FIG. 7.

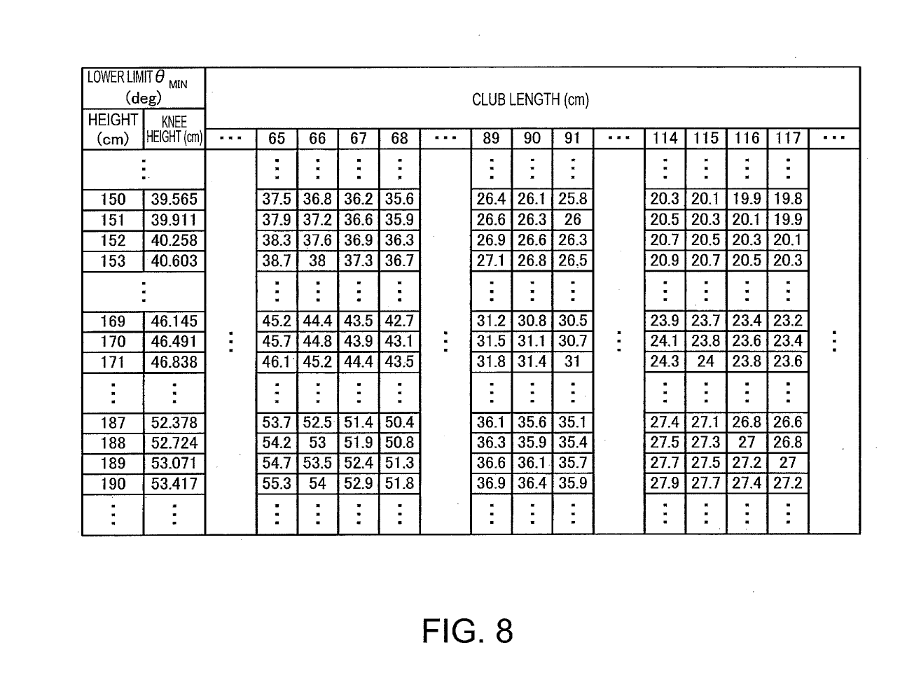

FIG. 8 is a diagram illustrating an example of table information (lookup table) that defines a lower limit θMIN (an inclination with respect to the horizontal plane (XY plane)) of the criterion range of the inclination angle θ of the golf club at the time of address of the user included in the criterion range information 248. In FIG. 8, heights or knee heights (unit: cm) are arranged in the column direction and club lengths (unit: cm) are arranged in the row direction. In the embodiment, the inclination angle θ when a height of the grip end of the golf club from the ground is nearly identical to the knee height is assumed to be the lower limit θMIN. The knee height is calculated by a correlation equation based on statistical data using the height as variables (more specifically, using sex, age, nationality, and the like as variables). When a is the club length and c is the knee height, the lower limit θMIN is calculated by arcsin(c/a). In the lookup table of FIG. 8, for example, as illustrated in FIG. 4A, the knee height of 46.491 cm is calculated for the user 2 of which the height is 170 cm (male, 36 year old, and Japanese). As illustrated in FIG. 4B, when the golf club 3 with a club length of 115 cm is used, the lower limit θMIN is defined as 23.8°.

The storage unit 24 is used as a work area of the processing unit 21 and temporarily stores, for example, data input from the operation unit 23 and calculation results performed according to various programs by the processing unit 21. The storage unit 24 may store data necessarily stored for a long time among the data generated through the processes of the processing unit 21.

The display unit 25 displays a processing result of the processing unit 21 as text, a graph, a table, animations, or another image. The display unit 25 may be, for example, a cathode ray tube (CRT), a liquid crystal display (LCD), a touch panel type display, or a head-mounted display (HMD). The functions of the operation unit 23 and the display unit 25 may be realized by one touch panel type display.

The sound output unit 26 outputs a processing result of the processing unit 21 as audio such as a sound or a buzzer tone. The sound output unit 26 may be, for example, a speaker or a buzzer.

The processing unit 21 performs a process of transmitting a control command to the sensor unit 10, various calculation processes on data received from the sensor unit 10 via the communication unit 22, and other various control processes according to various programs. In particular, in the embodiment, the processing unit 21 executes the inclination determination program 240 to function as a data acquisition unit 210, an inclination calculation unit 211, a determination unit 212, a first specifying unit 213, a second specifying unit 214, an exercise analysis unit 215, an image data generation unit 216, a storage processing unit 217, a display processing unit 218, and a sound output processing unit 219.

The data acquisition unit 210 receives the packet data received from the sensor unit 10 by the communication unit 22, acquires the time information and the measurement data from the received packet data, and performs a process of transmitting the time information and the measurement data to the storage processing unit 217.

The storage processing unit 217 receives the time information and the measurement data from the data acquisition unit 210 and performs a process of storing the time information and the measurement data in the storage unit 24 in association therewith. The inclination calculation unit 211 performs a process of calculating an inclination of the golf club 3 before swing start of the user 2 using the measurement data output by the sensor unit 10. In the embodiment, the user 2 performs the motion of S4 of FIG. 3. Then, when a change amount of the acceleration data measured by the acceleration sensor 12 does not continuously exceed a threshold value for a predetermined time, the inclination calculation unit 211 calculates the inclination angle θ of the shaft of the golf club 3 using the acceleration data within the predetermined time.

The determination unit 212 determines whether the inclination (inclination angle θ) of the golf club 3 calculated by the inclination calculation unit 211 is included within the criterion range decided based on the golf club information 242 and the body information 244. Specifically, the determination unit 212 decides the criterion range of the inclination angle θ of the golf club 3 according to the information regarding the club length included in the golf club information 242 and the information regarding the height included in the body information 244 with reference to the criterion range information 248 (the lookup table of FIG. 7 and the lookup table of FIG. 8). The determination unit 212 determines whether the inclination angle θ of the golf club 3 calculated by the inclination calculation unit 211 is included in the criterion range. For example, when the user 2 inputs the body information illustrated in FIG. 4A and the golf club information illustrated in FIG. 4B in S1 of FIG. 3, the determination unit 212 decides the criterion range of the inclination angle θ of the golf club 3 to a range equal to or greater than 23.8° and equal to or less than 42.1° based on the lookup table of FIG. 7 and the lookup table of FIG. 8 and determines whether the inclination angle θ of the golf club 3 calculated by the inclination calculation unit 211 is included in the range equal to or greater than 23.8° and equal to or less than 42.1°.

When the determination unit 212 determines that the inclination (inclination angle θ) of the golf club 3 is included in the criterion range, the first specifying unit 213 performs a process of specifying the first line segment 51 (see FIG. 5) which is the first axis which lines in the major axis direction of the golf club 3 using the measurement data output by the sensor unit 10 and stored in the storage unit 24. Specifically, the first specifying unit 213 specifies the first line segment 51 using the measurement data when the inclination angle θ of the golf club 3 is included in the criterion range. For example, the first specifying unit 213 may calculate the inclination angle of the shaft of the golf club 3 using the measurement data, calculate the coordinates of the position 62 of the grip end of the golf club 3 using the calculated inclination angle and information regarding the length (the length of the shaft) of the golf club 3 included in the golf club information 242, and specify a line segment connecting the position 61 (the origin O) of the head (blow portion) of the golf club 3 to the position 62 of the grip end as the first line segment 51.

The first specifying unit 213 performs a process of specifying the shaft plane (first imaginary plane) 30 (see FIG. 5) including the first line segment 51 and the third line segment 52 indicating the hitting target direction. The first specifying unit 213 may calculate the width of the shaft plane 30 using the length of the first line segment 51 and the length of the arm of the user 2 based on the body information 244.

When the determination unit 212 determines that the inclination of the golf club 3 is included in the criterion range, the second specifying unit 214 performs a process of specifying the second line segment 53 (see FIG. 5) which is the second axis connecting the blow position to the predetermined position 63 (for example, on a line segment connecting both shoulders) between the head and the chest of the user 2 using the measurement data output by the sensor unit 10 and stored in the storage unit 24. Specifically, the second specifying unit 214 specifies the second line segment 53 using the measurement data when the inclination of the golf club 3 is included in the criterion range. For example, the second specifying unit 214 may estimate the predetermined position 63 using the measurement data and the body information 244 and specify a line segment connecting the estimated predetermined position 63 to the position 61 (the origin O) of the head (blow portion) of the golf club 3 as the second line segment 53. For example, the second specifying unit 214 may estimate the predetermined position 63 using the coordinates of the position 62 of the grip end calculated by the first specifying unit 213 and the length of the arm of the user 2 based on the body information 244. Alternatively, the second specifying unit 214 may calculate the coordinates of the position 62 of the grip end of the golf club 3 using the measurement data when the inclination of the golf club 3 is included in the criterion range. In this case, the first specifying unit 213 may specify the first line segment 51 using the coordinates of the position 62 of the grip end calculated by the second specifying unit 214.

The second specifying unit 214 performs a process of specifying the Hogan's plane (second imaginary plane) 40 (see FIG. 5) including the second line segment 53 and the third line segment 52. The second specifying unit 214 may calculate the width of the Hogan's plane 40 using the length of the first line segment 51 and the length of the arm of the user 2 based on the body information 244.

The exercise analysis unit 215 performs a process of analyzing a swing motion of the user 2 using the measurement data output by the sensor unit 10. Specifically, the exercise analysis unit 215 first calculates an offset amount included in the measurement data using the measurement data (the acceleration data and the angular velocity data) at the time of stopping (the time of address) of the user 2 stored in the storage unit 24. Next, the exercise analysis unit 215 performs bias correction by subtracting the offset amount from the measurement data after swing start stored in the storage unit 24 and calculates the position and posture of the sensor unit 10 during a swing motion (during the motion of step S6 of FIG. 3) of the user 2 using the measurement data subjected to the bias correction.

For example, the exercise analysis unit 215 calculates the position (initial position) of the sensor unit 10 at the time of stopping (the time of address) of the user 2 in the XYZ coordinate system (global coordinate system), using the acceleration data measured by the acceleration sensor 12, the golf club information 242, and the sensor-mounted position information 246, integrates the subsequent acceleration data, and chronologically calculates a change in the position of the sensor unit 10 from the initial position. Since the user 2 performs the motion of step S4 of FIG. 3, the X coordinate of the initial position of the sensor unit 10 is 0. Further, as illustrated in FIG. 2, the y axis of the sensor unit 10 is identical to the major axis direction of the shaft of the golf club 3 and the acceleration sensor 12 measures only the gravity acceleration at the time of stopping of the user 2. Therefore, the exercise analysis unit 215 can calculate an inclination angle of the shaft using y-axis acceleration data. Then, the exercise analysis unit 215 obtains a distance LSH between the sensor unit 10 and the head from the golf club information 242 (the length of the shaft) and the sensor-mounted position information 246 (distance from the grip) and sets a position distant by the distance LSH from the origin in the negative direction of the y axis of the sensor unit 10 specified by the inclination angle of the shaft using the position of the head as the origin (0, 0, 0) as the initial position of the sensor unit 10. Alternatively, the exercise analysis unit 215 may calculate the coordinates of the initial position of the sensor unit 10 using the coordinates of the position 62 of the grip end of the golf club 3 calculated by the first specifying unit 213 or the second specifying unit 214 and the sensor-mounted position information 246 (the distance from the grip end).

The exercise analysis unit 215 calculates the posture (initial posture) of the sensor unit 10 at the time of stopping of the user 2 (the time of address) in the XYZ coordinate system (global coordinate system), using the acceleration data measured by the acceleration sensor 12, performs rotation calculation using the angular velocity data measured subsequently by the angular velocity sensor 14, and chronologically calculates a change in the posture from the initial posture of the sensor unit 10. The posture of the sensor unit 10 can be expressed by, for example, rotation angles (a roll angle, a pitch angle, and a yaw angle) around the X axis, the Y axis, and the Z axis, quaternions, or the like. At the time of stopping of the user 2, the acceleration sensor 12 measures only the gravity acceleration. Therefore, the exercise analysis unit 215 can specify an angle formed between of each of the x, y, and z axes of the sensor unit 10 and a gravity direction using triaxial acceleration data. Since the user 2 performs the motion of step S4 of FIG. 3, the y axis of the sensor unit 10 is present on the YZ plane of the y axis of the sensor unit 10 at the time of stopping of the user 2. Therefore, the exercise analysis unit 215 can specify the initial posture of the sensor unit 10.

The exercise analysis unit 215 sets a position distant by the distance LSH from the position of the sensor unit 10 at each time of the swing in the positive direction of the y axis of the sensor unit 10 specified from the posture of the sensor unit 10 at that time, as the position of the head at that time.

The exercise analysis unit 215 sets a position distant by a distance LSG between the grip and the sensor unit 10 specified by the sensor-mounted position information 246 (the distance from the grip) from the position of the sensor unit 10 at each time of the swing in the negative direction of the y axis of the sensor unit 10 specified by the posture of the sensor unit 10 at that time, as the position of the grip at that time.

The signal processing unit 16 of the sensor unit 10 may calculate the offset amount of the measurement data and perform bias correction on the measurement data or a bias correction function may be embedded in the acceleration sensor 12 and the angular velocity sensor 14. In this case, the bias correction of the measurement data by the exercise analysis unit 215 is not necessary.

The exercise analysis unit 215 detects a timing (timing of an impact) at which the user 2 hits the ball during the swing motion, using the time information and the measurement data stored in the storage unit 24. For example, the exercise analysis unit 215 calculates a composite value of the measurement data (the acceleration data or the angular velocity data) output by the sensor unit 10 and specifies the timing (time) at which the user 2 hits the ball based on the composite value.

The exercise analysis unit 215 determines whether a trajectory (chronological information regarding the position of the head of the golf club 3 and the position of the grip) of the golf club 3 in a downswing up to a swing (in particular, at the time of hitting (the time of an impact) from a time at which the golf club 3 is present at the top position) is included in a space (V zone) between the shaft plane 30 and the Hogan's plane 40, and then generates evaluation information of the swing of the user 2 based on the determination result.

Based on the measurement data of the sensor unit 10, the exercise analysis unit 215 may analyze a rhythm of a swing from a backswing to follow-through, a head speed, an incident angle (club pass) or a face angle at the time of hitting, shaft rotation (a change amount of face angle during the swing), information regarding a deceleration rate or the like of the golf club 3, or information regarding a variation in each piece of information when the user 2 performs the swing a plurality of times.

The image data generation unit 216 performs a process of generating image data corresponding to an image of an exercise analysis result displayed on the display unit 25. In particular, in the embodiment, the image data generation unit 216 generates image data including the shaft plane 30 specified by the first specifying unit 213, the Hogan's plane 40 specified by the second specifying unit 214, and the trajectory of the golf club 3 at a swing (in particular, a downswing) of the user 2, which is calculated by the exercise analysis unit 215. For example, the image data generation unit 216 generates polygon data of the shaft plane 30 having the four vertexes T1, T2, S1, and S2 illustrated in FIG. 5 based on information regarding the coordinates of T1, T2, S1, and S2 and generates polygon data of the Hogan's plane 40 having the four vertexes T1, T2, H1, and H2 based on information regarding the coordinates of T1, T2, H1, and H2.

The image data generation unit 216 generates curved-line data indicating the trajectory of the golf club 3 at the time of the downswing of the user 2. Then, the image data generation unit 216 generates image data including the polygon data of the shaft plane 30, the polygon data of the Hogan's plane 40, and the curved-line data indicating the trajectory of the golf club 3.

The storage processing unit 217 performs a reading or writing process of various programs or various kinds of data from or on the storage unit 24. The storage processing unit 217 performs not only a process of storing the time information and the measurement data received from the data acquisition unit 210 in the storage unit 24 in association therewith but also a process of storing various kinds of information calculated by the first specifying unit 213, the second specifying unit 214, and the exercise analysis unit 215 in the storage unit 24.

The display processing unit 218 performs a process of causing the display unit 25 to display various images (including not only an image corresponding to the image data generated by the image data generation unit 216 but also text or signs). For example, the display processing unit 218 causes the display unit 25 to display the image corresponding to the image data generated by the image data generation unit 216 or text or the like indicating the analysis result by the exercise analysis unit 215 automatically or according to an input operation of the user 2 after a swing exercise of the user 2 ends. Alternatively, the sensor unit 10 may include a display unit, the display processing unit 218 may transmit the image data to the sensor unit 10 via the communication unit 22, and various images or text may be displayed on the display unit of the sensor unit 10.

The sound output processing unit 219 performs a process of causing the sound output unit 26 to output various sounds (also including voice or buzzer sound). For example, the sound output processing unit 219 reads various kinds of information stored in the storage unit 24 and causes the sound output unit 26 to output sound or voice for exercise analysis automatically or at the time of performing a predetermined input operation after a swing motion of the user 2 ends. Alternatively, the sensor unit 10 may include an sound output unit, the sound output processing unit 219 may transmit various kinds of sound data or voice data to the sensor unit 10 via the communication unit 22, and may cause the sound output unit of the sensor unit 10 to output the various sounds or voices.

In particular, in the embodiment, when the determination unit 212 determines that the inclination of the golf club 3 is included in the criterion range, the sound output processing unit 219 generates voice data to notify the user 2 of swing start permission and causes the sound output unit 26 to function as a notification unit so that the user 2 is notified of the swing start permission through a voice. Alternatively, when the determination unit 212 determines that the inclination of the golf club 3 is included in the criterion range, the image data generation unit 216 generates data such as an image or text to notify the user 2 of the swing start permission and the display processing unit 218 causes the display unit 25 to function as a notification unit so that the user 2 is notified of the swing start permission through an image, text, or the like.

The inclination determination device 20 or the sensor unit 10 may include a vibration mechanism and various kinds of information may be converted into vibration information by the vibration mechanism so that the user 2 is notified of the vibration information.

### 1-3. Process of Inclination Determination Device

### Exercise Analysis Process

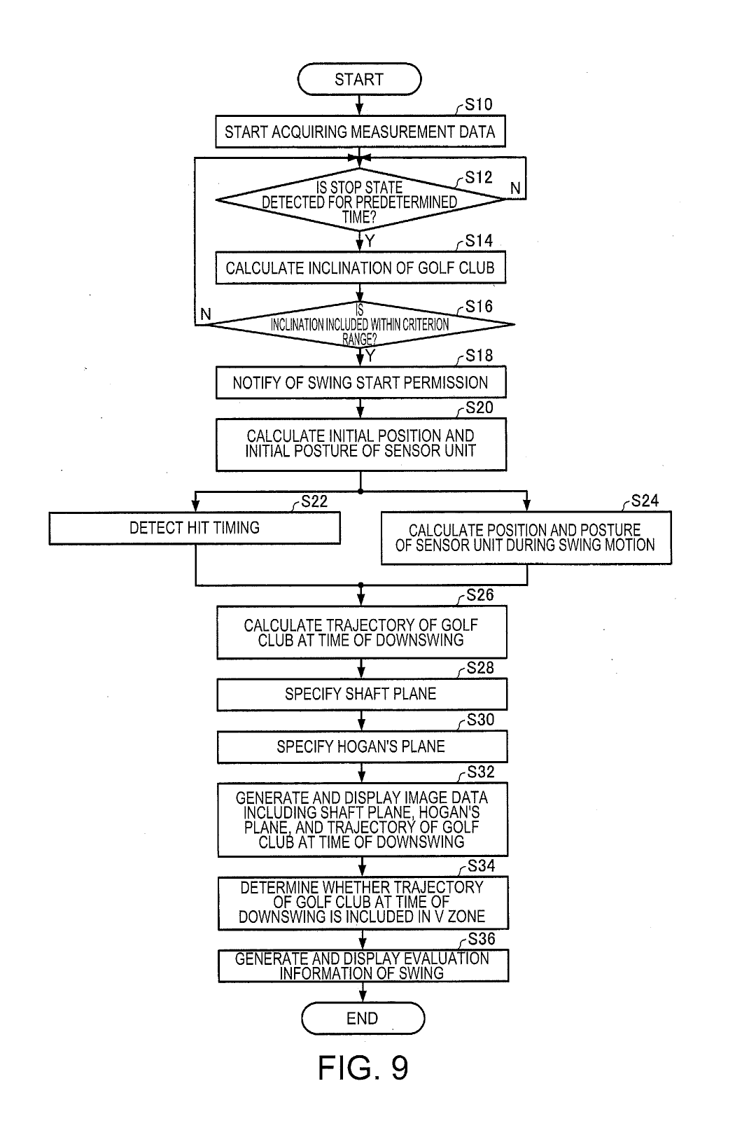

FIG. 9 is a flowchart illustrating a procedure example of the exercise analysis process performed by the processing unit 21 according to the embodiment. The processing unit 21 performs a part of the exercise analysis process in the procedure of the flowchart of FIG. 9 by executing the inclination determination program 240 (exercise analysis program) stored in the storage unit 24. Hereinafter, the flowchart of FIG. 9 will be described.

First, the processing unit 21 starts acquiring the measurement data from the sensor unit 10 (S10).

Next, the processing unit 21 continuously detects a stop state for a predetermined time using the measurement data acquired from the sensor unit 10 through a stopping motion (address motion) (the motion of step S4 of FIG. 3) of the user 2 (Y of S12) and calculates the inclination (inclination angle θ) of the golf club 3 using the measurement data acquired within the predetermined time (S14).

Next, the processing unit 21 determines whether the inclination (inclination angle θ) of the golf club 3 calculated in step S14 is included in the criterion range, using the golf club information 242, the body information 244, and the criterion range information 248 (S16).

When the inclination (inclination angle θ) of the golf club 3 is not included in the criterion range (N of S16), the processing unit 21 returns the process to step S12. When the inclination (inclination angle θ) is included in the criterion range (Y of S16), the user 2 is notified of the swing start permission (S18). For example, the processing unit 21 outputs a predetermined image or sound or the sensor unit 10 includes an LED to turn off and on the LED so that the user 2 is notified of the swing start permission, and then the user 2 starts a swing after confirming the notification. Next, the processing unit 21 performs processes subsequent to step S20 in real time during the swing motion of the user 2 or after end of the swing.

First, the processing unit 21 calculates the initial position and the initial posture of the sensor unit 10 using the measurement data (the measurement data in the stopping motion (address motion) of the user 2) acquired from the sensor unit 10 (S20).

Next, the processing unit 21 detects a timing (timing of an impact) at which the user 2 hits the ball using the measurement data acquired from the sensor unit 10 (S22).

The processing unit 21 calculates the position and posture of the sensor unit 10 during the swing motion of the user 2 concurrently with the process of step S22 or before or after the process of step S22 (S24).

Next, the processing unit 21 calculates the trajectory of the golf club 3 at the time of a downswing of the user 2 using the timing of the impact detected in step S22 and the position and posture of the sensor unit 10 calculated in step S24 (S26).

Next, the processing unit 21 specifies the shaft plane 30 using the measurement data (the measurement data for a period in which the inclination of the golf club 3 is determined to be included in the criterion range) acquired from the sensor unit 10 and the golf club information 242 (S28).

Next, the processing unit 21 specifies the Hogan's plane 40 using the measurement data (the measurement data for a period in which the inclination of the golf club 3 is included in the criterion range) acquired from the sensor unit 10 and the body information 244 (S30).

Next, the processing unit 21 generates the image data including the shaft plane 30 specified in step S28, the Hogan's plane 40 specified in step S30, and the trajectory of the golf club at the time of the downswing calculated in step S26 and causes the display unit 25 to display the image data (S32).

The processing unit 21 determines whether the trajectory of the golf club 3 at the time of the downswing is included in the V zone (the space between the shaft plane 30 and the Hogan's plane 40) (S34).

Next, the processing unit 21 generates the evaluation information of the swing of the user 2 using the determination result of step S34 and causes the display unit 25 to display the evaluation information (S36). Then, the process ends.

In the flowchart of FIG. 9, the sequence of the steps may be appropriately changed within a possible range.

### Process of Specifying Shaft Plane (First Imaginary Plane)

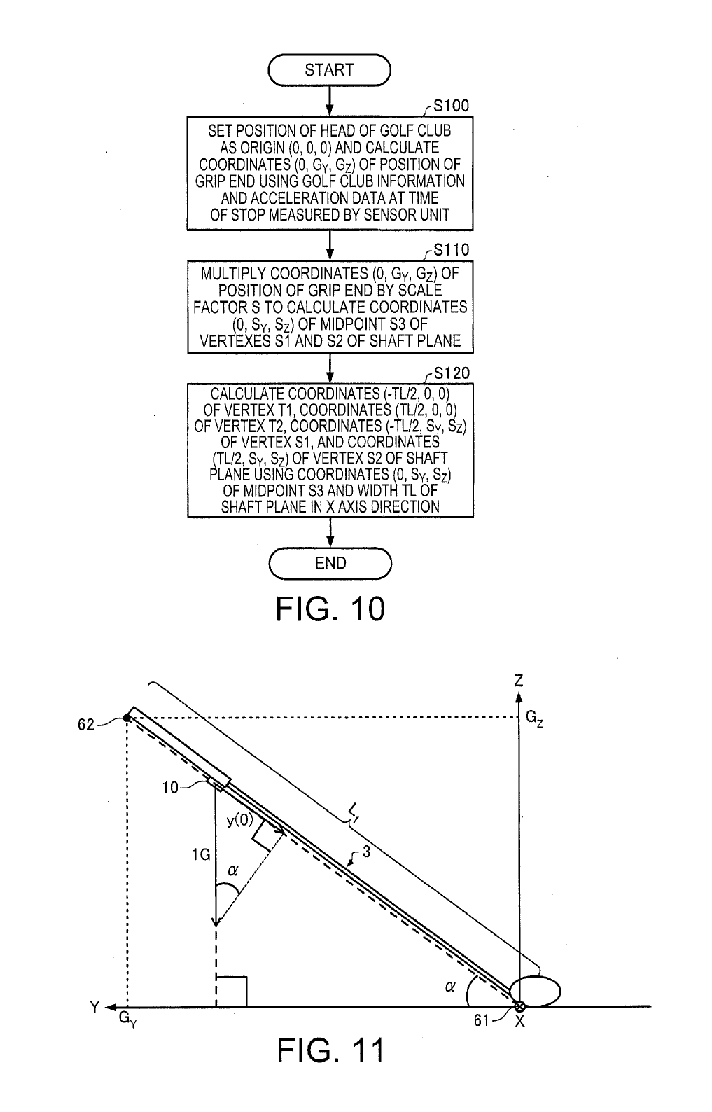

FIG. 10 is a flowchart illustrating a procedure example of the process (the process of step S28 of FIG. 9) of specifying the shaft plane (first imaginary plane) by the processing unit 21 according to the embodiment. Hereinafter, the flowchart of FIG. 10 will be described.

As illustrated in FIG. 5, the processing unit 21 first sets the position 61 of the head of the golf club 3 as the origin O (0, 0, 0) of the XYZ coordinate system (global coordinate system) and calculates the coordinates (0, GY, GZ) of the position 62 of the grip end using the golf club information 242 and the acceleration data measured by the sensor unit 10 for the period in which the inclination of the golf club 3 is determined to be included in the criterion range (S100). FIG. 11 is a plan view illustrating the golf club 3 and the sensor unit 10 at the time of stopping (the time of address) of the user 2 when viewed from the negative side of the X axis. The position 61 of the head of the golf club 3 is the origin O (0, 0, 0) and the coordinates of the position 62 of the grip end are (0, GY, GZ). As illustrated in FIG. 11, since the gravity acceleration G is applied to the sensor unit 10 at the time of stopping of the user 2, a relation between the y axis acceleration y(0) and an inclination angle (an angle formed by the major axis of the shaft and the horizontal plane (XY plane)) a of the shaft of the golf club 3 is expressed in equation (1).

y(0)=G·sin α (1)

Accordingly, when L1 is the length of the shaft of the golf club 3 included in the golf club information 242, GY and GZ are calculated using the length L1 and the inclination angle α of the shaft in equations (2) and (3), respectively.

G_{Y}=L₁·cos α (2)

G_{Z}=L₁·sin α (3)

Next, the processing unit 21 multiplies the coordinates (0, GY, GZ) of the position 62 of the grip end of the golf club 3 by a scale factor S to calculate the coordinates (0, SY, SZ) of a midpoint S3 of the vertexes S1 and S2 of the shaft plane 30 (S110). That is, SY and SZ are calculated using equations (4) and (5).

S_{Y}=G_{Y}·S (4)

S_{Z}=G_{Z}·S (5)

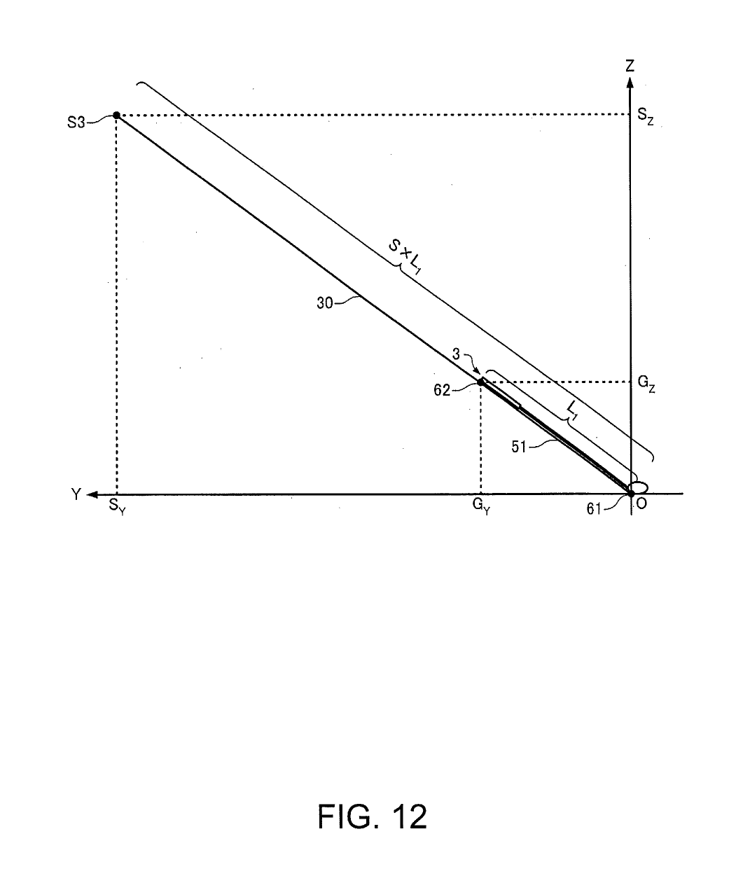

FIG. 12 is a diagram illustrating a cross section obtained by cutting the shaft plane 30 in FIG. 5 along the YZ plane when viewed from the negative side of the X axis. As illustrated in FIG. 12, the length (the width of the shaft plane 30 in a direction perpendicular to the X axis) of a line segment connecting the origin O to the midpoint S3 of the vertexes S1 and S2 is S times the length L1 of the first line segment 51. The scale factor S is set to a value so that the trajectory of the golf club 3 during the swing motion of the user 2 falls within the shaft plane 30. For example, when L2 is the length of an arm of the user 2, the scale factor S may be set as in equation (6) so that a width S×L1 in the direction perpendicular to the X axis of the shaft plane 30 is twice a sum of the length L1 of the shaft and the length L2 of the arm.

$$S = \frac{2 \cdot ( {L}_{1} + {L}_{2} )}{{L}_{1 }} \qquad ( 6 )$$

The length L2 of the arm of the user 2 has correlation with a height L0 of the user 2. For example, based on statistical information, a correlation equation as in equation (7) is expressed when the user 2 is male, and a correlation equation as in equation (8) is expressed when the user 2 is female.

L₂=0.41×L₀−45.5[mm] (7)

L₂=0.46×L₀−126.9[mm] (8)

Accordingly, the length L2 of the arm of the user is calculated by equation (7) or (8) using the height L0 and sex of the user 2 included in the body information 244.

Next, the processing unit 21 calculates the coordinates (−TL/2, 0, 0) of the vertex T1, the coordinates (TL/2, 0, 0) of the vertex T2, the coordinates (−TL/2, SY, SZ) of the vertex S1, and the coordinates (TL/2, SY, SZ) of the vertex S2 of the shaft plane 30 using the coordinates (0, SY, SZ) of the midpoint S3 calculated in step S110 and the width (the length of the third line segment 52) TL of the shaft plane 30 in the X axis direction (S120). The width TL in the X axis direction is set to a value so that the trajectory of the golf club 3 during the swing motion of the user 2 falls within the shaft plane 30. For example, the width TL in the X axis direction may be set to be the same as the width S×L1 in the direction perpendicular to the X axis, that is, twice the sum of the length L1 of the shaft and the length L2 of the arm.

The shaft plane 30 is specified based on the coordinates of the four vertexes T1, T2, S1, and S2 calculated in this way.

### Process of Specifying Hogan's Plane (Second Imaginary Plane)

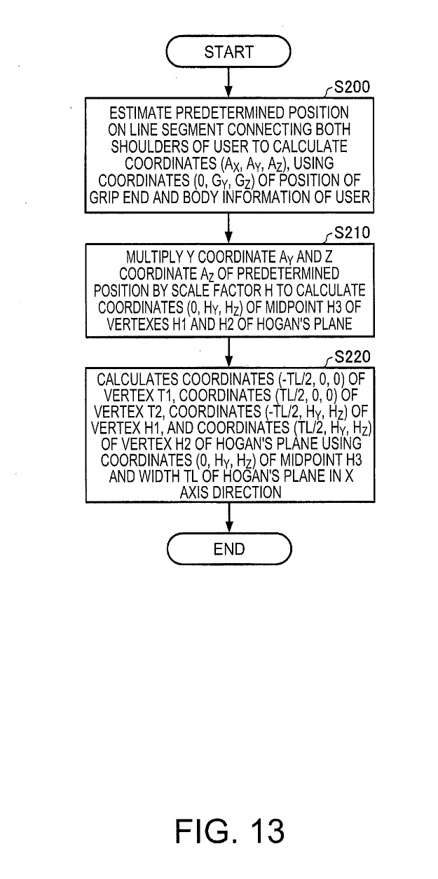

FIG. 13 is a flowchart illustrating a procedure example of the process (the process of step S30 of FIG. 9) of specifying the Hogan's plane (second imaginary plane) by the processing unit 21 according to the embodiment.

Hereinafter, the flowchart of FIG. 13 will be described.

First, the processing unit 21 estimates the predetermined position 63 on the line segment connecting both shoulders of the user 2 to one another to calculate the coordinates (AX, AY, AZ), using the coordinates (0, GY, GZ) of the position 62 of the grip end of the golf club 3 calculated in step S100 of FIG. 10 and the body information 244 of the user 2 (S200).

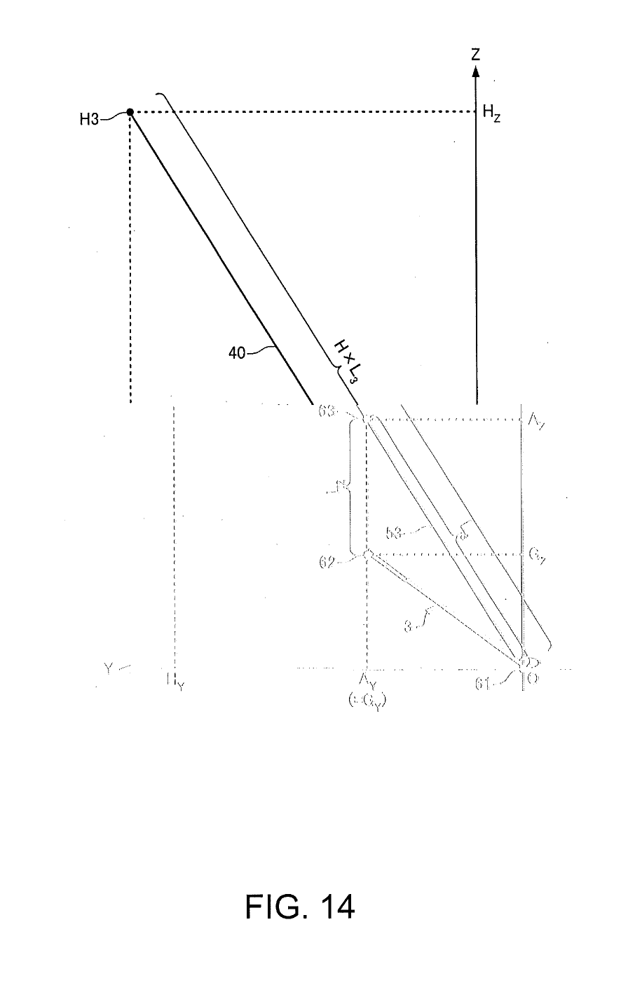

FIG. 14 is a diagram illustrating a cross section obtained by cutting the Hogan's plane 40 in FIG. 5 along the YZ plane when viewed on the negative side of the X axis. In FIG. 14, the midpoint of the line segment connecting both shoulders of the user 2 to one another is set as the predetermined position 63, and the predetermined position 63 is present on the YZ plane. Accordingly, the X coordinate AX of the predetermined position 63 is 0. As illustrated in FIG. 14, the processing unit 21 estimates that a position moved from the position 62 of the grip end of the golf club 3 by the length L2 of the arm of the user 2 in the positive direction of the Z axis is the predetermined position 63. Accordingly, the Y coordinate AY of the predetermined position 63 is the same as the Y coordinate GY of the position 62 of the grip end, and the Z coordinate AZ of the predetermined position 63 is calculated as a sum of the Z coordinate GZ of the position 62 of the grip end and the length L2 of the arm of the user 2, as in equation (9).

A_{Z}=G_{Z}+L₂ (9)

The length L2 of the arm of the user is calculated in equation (7) or (8) using the height L0 and sex of the user 2 included in the body information 244.

Next, the processing unit 21 multiples the Y coordinate AY and the Z coordinate AZ of the predetermined position 63 by a scale factor H to calculate the coordinates (0, HY, HZ) of a midpoint H3 of the vertexes H1 and H2 of the Hogan's plane 40 (S210). That is, HY and HZ are calculated using equations (10) and (11).

H_{Y}=A_{Y}·H (10)

H_{Z}=A_{Z}·H (11)

As illustrated in FIG. 14, a length (a width of the Hogan's plane 40 in a direction perpendicular to the X axis) of a line segment connecting the origin O to the midpoint H3 of the vertexes H1 and H2 is H times the length L3 of the second line segment 53. The scale factor H is set to a value so that the trajectory of the golf club 3 during the swing motion of the user 2 falls within the Hogan's plane 40. For example, the Hogan's plane 40 may have the same shape and size as the shaft plane 30. In this case, since a width H×L3 of the Hogan's plane 40 in the direction perpendicular to the X axis is identical to the width S×L1 of the shaft plane 30 in the direction perpendicular to the X axis and is twice the sum of the length L1 of the shaft of the golf club 3 and the length L2 of the arm of the user 2, the scale factor H may be set as in equation (12).

$$H = \frac{2 \cdot ( {L}_{1} + {L}_{2} )}{{L}_{3 }} \qquad ( 12 )$$

The length L3 of the second line segment 53 is calculated from equation (13) using the Y coordinate AY and the Z coordinate AZ of the predetermined position 63.

L₃=\sqrt{A_{Y}²+A_{Z}²} (13)

Next, the processing unit 21 calculates the coordinates (−TL/2, 0, 0) of the vertex T1, the coordinates (TL/2, 0, 0) of the vertex T2, the coordinates (−TL/2, HY, HZ) of the vertex H1, and the coordinates (TL/2, HY, HZ) of the vertex H2 of the Hogan's plane 40 using the coordinates (0, HY, HZ) of the midpoint H3 calculated in step S210 and the width (the length of the third line segment 52) TL of the Hogan's plane 40 in the X axis direction (S220). The width TL in the X axis direction is set to a value so that the trajectory of the golf club 3 during the swing motion of the user 2 falls within the Hogan's plane 40. In the embodiment, for example, the width TL of the Hogan's plane 40 in the X axis direction may be set to be the same as the width of the shaft plane 30 in the X axis direction, and thus may be set to be twice the sum of the length L1 of the shaft and the length L2 of the arm, as described above.

The Hogan's plane 40 is specified based on the coordinates of the four vertexes T1, T2, H1, and H2 calculated in this way.

### Impact Detection Process

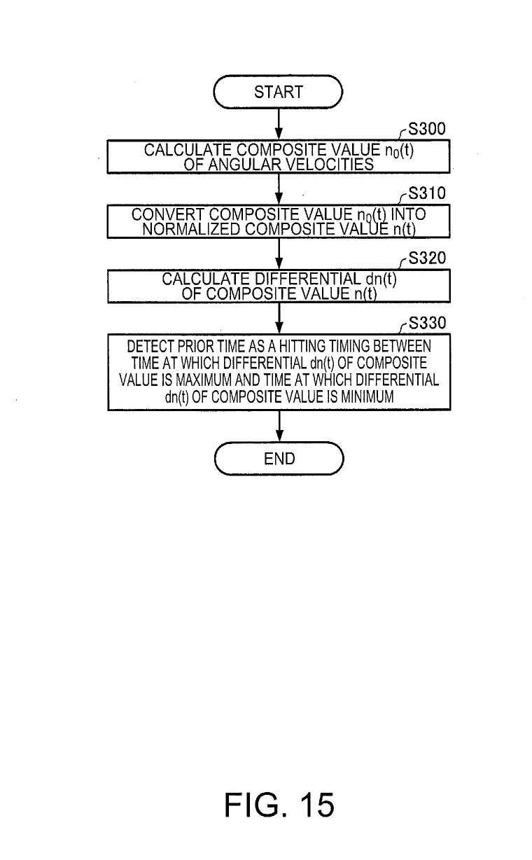

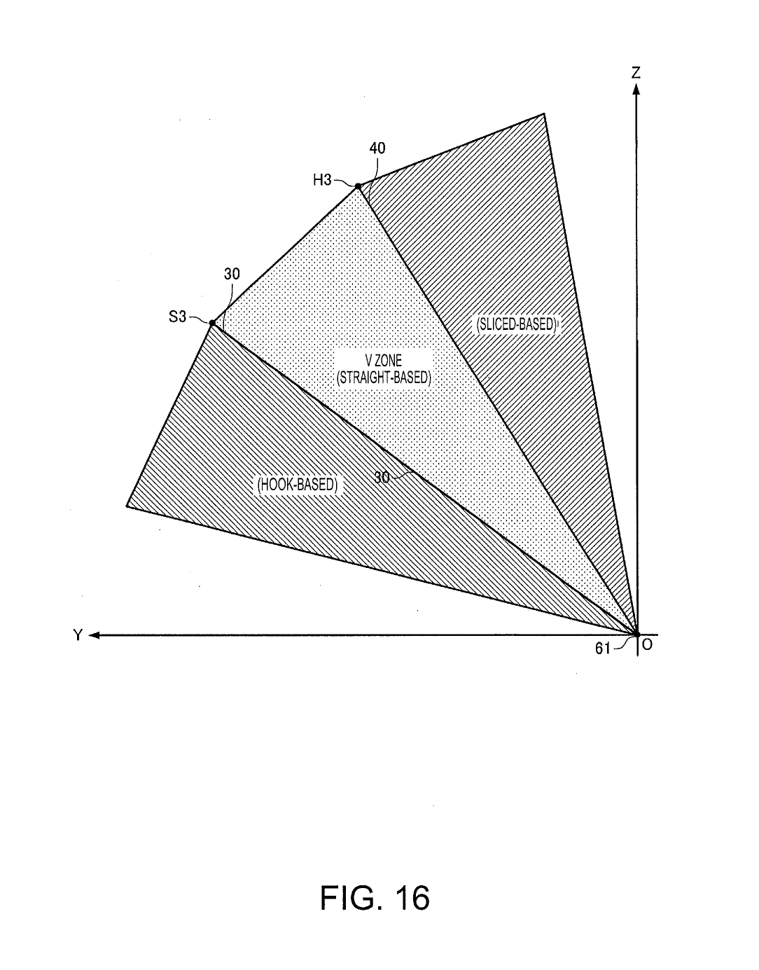

FIG. 15 is a flowchart illustrating a procedure example of the process (the process of step S22 of FIG. 9) of detecting the timing at which the user 2 hits the ball. Hereinafter, the flowchart of FIG. 15 will be described.

The processing unit 21 first calculates the value of the composite value n0(t) of the angular velocities at each time t using the acquired angular velocity data (the angular velocity data at each time t) (S300). For example, when x(t), y(t), and z(t) are angular velocity data at time t, the composite value n0(t) of the angular velocity is calculated in equation (14) below.

n₀(t)=\sqrt{x(t)²+y(t)²+z(t)²} (14)

Next, the processing unit 21 converts the composite value n0(t) of the angular velocities at each time t into a composite value n(t) normalized (scale-converted) in a predetermined range (S310). For example, when max(n0) is the maximum value of the composite value of the angular velocities during an acquisition period of the measurement data, the composite value n0(t) of the angular velocities is converted into the composite value n(t) normalized in a range of 0 to 100 by equation (15) below.

$$n ( t ) = \frac{100 \times {n}_{0} ( t )}{max ( {n}_{0} )} \qquad ( 15 )$$

Next, the processing unit 21 calculates a differential dn(t) of the composite value n(t) after the normalization at each time t (S320). For example, when Δt is a measurement period of triaxial angular velocity data, the differential (difference) dn(t) of the composite value of the angular velocities at the time t is calculated in equation (16) below.

dn(t)=n(t)−n(t−Δt) (16)

Finally, the processing unit 21 detects a prior time as a hitting timing between a time at which the value of the differential dn(t) of the composite value is the maximum and a time at which the differential dn(t) of the composite value is the minimum (S330). In a normal golf swing, a swing speed is considered to be the maximum at a moment of the hitting. Since the composite value of the angular velocities is considered to be also changed according to the swing speed, a timing at which the differential value of the composite value of the angular velocities is the maximum or minimum during a series of swing motions (that is, a timing at which the differential value of the composite value of the angular velocities is the positive maximum value or the negative minimum value) can be captured as a timing of the hitting (impact). Since the golf club 3 is vibrated by the hitting, the timing at which the differential value of the composite value of the angular velocities is the maximum and the timing at which the differential value of the composite value of the angular velocities is the minimum are considered to be paired, but the former timing between the timings is considered to be the moment of the hitting.

When the user 2 performs the swing motion, a series of rhythm in which the user 2 stops the golf club at the top position, performs a downswing, hits a ball, and performs follow-through is assumed. Accordingly, the processing unit 21 detects candidates for the timing at which the user 2 hits the ball according to the flowchart of FIG. 15 and determines whether the measurement data before and after the detected timing matches this rhythm. When the measurement data matches each other, the detected timing may be confirmed as the timing at which the user 2 hits the ball. When the measurement data does not match the rhythm, a subsequent candidate may be detected. In the flowchart of FIG. 15, the processing unit 21 detects the timing of the hitting using the triaxial angular velocity data. However, the timing of the hitting can also be detected using triaxial acceleration data in the same manner.

### 1-4. Swing Evaluation

FIG. 16 is a diagram illustrating the shaft plane 30 and the Hogan's plane 40 in FIG. 5 when viewed from the negative side of the X axis (a diagram projected to the YZ plane). As illustrated in FIG. 16, when all of the trajectories of the golf club 3 at the time of the downswing of the user 2 are included in the V zone which is the space between the shaft plane 30 and the Hogan's plane 40, there is a high possibility of the hitting becoming straight-based hitting. Conversely, when some of the trajectories of the golf club 3 at the time of the downswing of the user 2 are included in a space lower than the V zone, there is a high possibility of the hitting being hook-based hitting. When some of the trajectories of the golf club 3 at the time of the downswing of the user 2 are included in a space higher than the V zone, there is a high possibility of the hitting becoming slice-based hitting. Accordingly, for example, in step S34 of FIG. 9, the processing unit 21 may determine whether all of the trajectories of the golf club 3 at the time of the downswing of the user 2 are included in the V zone. Then, in step S36 of FIG. 9, the processing unit 21 may evaluate that the downswing is an appropriate swing when all of the trajectories of the golf club 3 at the time of the downswing are included in the V zone. Further, the processing unit 21 may evaluate that the downswing is an inappropriate swing which is a hook-based or slice-based swing when some of the trajectories of the golf club 3 at the time of the downswing are not included in the V zone. At the time of display, the planes may not be displayed. As in FIG. 16, only the first line segment 51 of the shaft plane 30 and the second line segment 53 of the Hogan's plane 40 may be displayed to evaluate a swing.

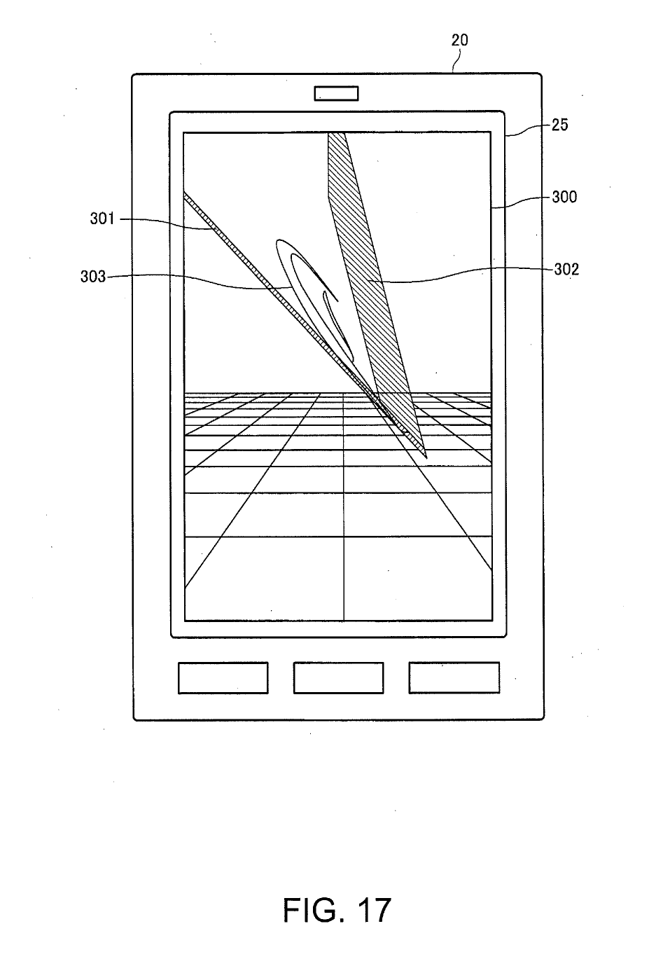

FIG. 17 illustrates an example of an image generated by the processing unit 21 in step S32 of FIG. 9 and displayed by the display unit 25. An image 300 illustrated in FIG. 17 includes a polygon 301 indicating the shaft plane 30, a polygon 302 indicating the Hogan's plane 40, and curved lines 303 indicating trajectories of the golf club 3 at the time of a downswing of the user 2. In the image 300 illustrated in FIG. 17, all of the curved lines 303 are included in the V zone which is a space between the polygons 302 and 301. Accordingly, when the user views the image 300, the user 2 can confirm that his or her swings are appropriate. When the image 300 (which is an image in which all of the curved lines 303 are included in the V zone) illustrated in FIG. 17 is displayed on the display unit 25, the processing unit 21 may evaluate that the swing of the user 2 is appropriate in step S36 of FIG. 9 and cause the display unit 25 to display information regarding the evaluation result along with the image 300.

The image 300 illustrated in FIG. 17 may be a still image or a moving image. The image 300 may also be a 3-dimensional image of which a display angle (a viewpoint at which the image 300 is viewed) can be changed through an operation of the user 2.

### 1-5. Advantages

In the embodiment, when the user 2 takes an appropriate address posture before swing start, the inclination determination device 20 determines whether the inclination angle θ before the swing start is included in the criterion range decided based on the golf club information 242 and the body information 244, focusing on the fact that an appropriate range of the inclination (inclination angle θ) of the golf club 3 is decided according to the golf club 3 or the user 2. Accordingly, in the embodiment, it is possible to determine whether the inclination of the exercise tool before exercise start of the user is included in an appropriate range. In particular, in the embodiment, the inclination determination device 20 can more accurately determine whether the inclination of the exercise tool before the exercise start of the user is included in the appropriate range by setting the criterion range of the inclination (inclination angle θ) of the golf club 3 more accurately according to the length of the golf club 3 or the height, sex, age, nationality, and the like of the user 2.

In the embodiment, the inclination determination device 20 notifies the user 2 of the swing start permission only when the inclination of the exercise tool before the exercise start of the user is included in the appropriate range. Therefore, the user 2 can confirm whether the user 2 takes an appropriate address posture and perform a better swing.

In the embodiment, the inclination determination device 20 does not notify the user 2 of the swing start permission when the user 2 leans the golf club 3 against a wall after a measurement start operation or stops before an address posture, but when the inclination (inclination angle θ) of the golf club 3 is not included in the criterion range despite measurement for a predetermined time and detection of the stop. Therefore, it is possible to reduce a concern that an erroneous swing analysis result is presented.

In the embodiment, when the user 2 views the image 300 displayed on the display unit 25 of the inclination determination device 20, the user 2 can objectively recognize the address posture based on the positions or inclinations of the shaft plane 30 and the Hogan's plane 40 and the size of the V zone. Since the user 2 can recognize the trajectory of the golf club 3 at the time of the downswing and a positional relation between the shaft plane 30 and the Hogan's plane 40 (whether the trajectory of the golf club 3 enters the V zone), it is possible to evaluate goodness and badness of the swing. In the embodiment, the inclination determination device 20 can specify the Hogan's plane 40 suitable for the shape of the user 2 by setting the Z coordinate AZ of the predetermined position 63 on the line segment connecting both shoulders of the user 2 to the sum of the Z coordinate GZ of the position 62 of the grip end present in the shaft plane 30 and the length L2 of the arm of the user 2.

In the embodiment, the inclination determination device 20 calculates the length L2 of the arm from the information regarding the height included in the body information 244 of the user 2, using the correlation equation between the length of the arm and the height derived based on the statistical data. It is not necessary for the user 2 to input the information regarding the length of the arm of which the user 2 does not normally know an accurate numerical value, and convenience is also good.

In the embodiment, the shaft plane 30 and the Hogan's plane 40 are specified using the sensor unit 10. Therefore, it is not necessary to use a large-scale device such as a camera and restriction of a place where a swing is analyzed is small.

In the embodiment, the inclination determination device 20 determines whether the trajectory of the golf club 3 in the downswing enters the V zone and presents the evaluation information regarding the swing based on the determination result. Therefore, the user 2 can evaluate the goodness and badness of the swing objectively and easily.

### Second Embodiment

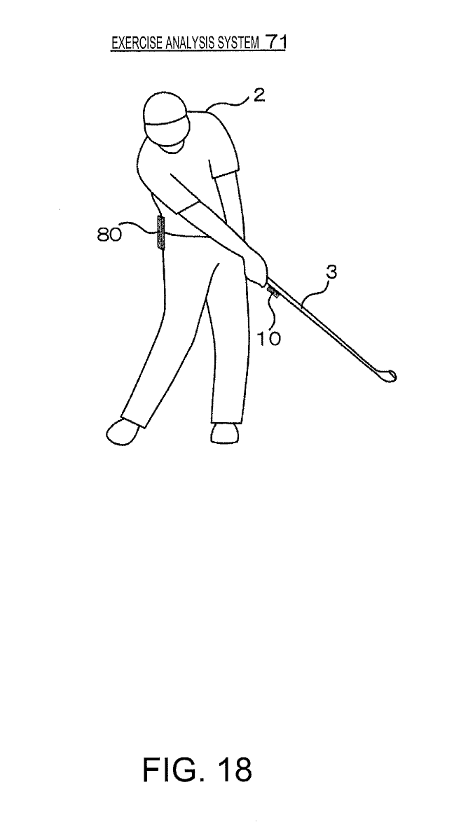

FIG. 18 is a diagram illustrating an overview of an exercise analysis system according to a second embodiment of the invention.

Hereinafter, the embodiment of the invention will be described with reference to the drawings. Hereinafter, an exercise analysis system analyzing a golf swing will be described as an example.

An exercise analysis system 71 includes a sensor unit 10 and an exercise analysis device 80.

As an inertial sensor, the sensor unit 10 can measure an acceleration generated in each axis direction of three axes and an angular velocity generated in each rotation of the three axes and is mounted on a golf club 3 which is an example of an exercise tool. For example, the sensor unit 10 is fitted on a part of the shaft of the golf club 3 when one axis among three detection axes (the x axis, the y axis, and the z axis), for example, the y axis, conforms to the major axis direction of the shaft. Preferably, the sensor unit 10 is fitted at a position close to a grip in which a shock at the time of shot is rarely delivered and a centrifugal force is not applied at the time of a swing. The shaft is a portion of the handle excluding the head of the golf club 3 and also includes the grip.

A user 2 performs a swing motion of hitting a golf ball (not illustrated) in a pre-decided procedure. For example, the user 2 first holds the golf club 3, takes a posture of address so that the major axis of the shaft of the golf club 3 is vertical to a target line (for example, a hitting target direction), and stops for a predetermined time or more (for example, 1 second or more). Next, the user 2 performs a swing motion to hit the golf ball (which is also referred to as a shot or a stroke). The posture of address in the present specification includes a posture in a stop state of the user before swing start or a posture in a state in which the user shakes an exercise tool (which is also referred to as waggling) before swing start. The target line refers to any hitting direction and is decided as, for example, a hitting target direction in the embodiment. While the user 2 performs the motion to hit the golf ball in the above-described procedure, the sensor unit 10 measures triaxial accelerations and triaxial angular velocities at a predetermined period (for example, 1 ms) and sequentially transmits the measurement data to the exercise analysis device 80. The sensor unit 10 may immediately transmit the measurement data, or may store the measurement data in an internal memory and transmit the measurement data at a desired timing such as the end of a swing motion of the user 2. Communication between the sensor unit 10 and the exercise analysis device 80 may be wireless communication or wired communication. Alternatively, the sensor unit 10 may store the measurement data in a recording medium such as a memory card which can be detachably mounted and the exercise analysis device 80 may read the measurement data from the recording medium.

The exercise analysis device 80 analyzes a swing exercise performed with the golf club 3 by the user 2 using the data measured by the sensor unit 10. In particular, in the embodiment, the exercise analysis device 80 specifies a shaft plane (which corresponds to a first imaginary plane or a first axis according to the invention) and a Hogan's plane (which corresponds to a second imaginary plane or a second axis according to the invention) at the time of stopping of the user 2 (the time of address) using the data measured by the sensor unit 10. The exercise analysis device 80 calculates a trajectory of the golf club 3 in a swing after the user 2 starts the swing motion. The exercise analysis device 80 generates image data including the trajectory of the golf club 3, the shaft plane, and the Hogan's plane in the swing of the user 2 and causes a display unit to display an image according to the image data. By displaying the shaft plane and the Hogan's plane, it is possible to recognize a space called a V zone between the shaft plane and the Hogan's plane. The exercise analysis device 80 may be, for example, a portable device such as a smartphone or a personal computer (PC). In FIG. 18, the exercise analysis device 80 is mounted on the waist of the user 2, but the mounted position is not particularly limited. Further, the exercise analysis device 80 may not be mounted on the user 2.

Here, examples of the shaft plane and the Hogan's plane in an exercise analysis system (exercise analysis device) according to the embodiment will be described with reference to FIG. 5. In FIG. 5, the shaft plane 30 at the time of address of the user 2 is an imaginary plane which includes the first line segment 51 serving as the first axis which lies in the major axis direction of the shaft of the golf club 3 and the third line segment 52 serving as the third axis indicating the hitting target direction and has four vertexes T1, T2, S1, and S2. In the embodiment, the position 61 of the head (blow portion) of the golf club 3 is set as the origin O (0, 0, 0) of the XYZ coordinate system. The first line segment 51 is a line segment which connects the position 61 (the origin O) of the head of the golf club 3 to a position 62 of a grip end. The third line segment 52 is a line segment which has T1 and T2 on the X axis as both ends, has a length TL, and centers on the origin O. When the user 2 takes the above-described address posture at the time of the address, the shaft of the golf club 3 is vertical to the target line (the X axis). Therefore, the third line segment 52 is a line segment which is perpendicular to the major axis direction of the shaft of the golf club 3 (which can also be a line segment perpendicular to or which intersects the blow surface of the head on which a ball is hit), that is, a line segment perpendicular to the first line segment 51. The shaft plane 30 is specified by calculating the coordinates of the four vertexes T1, T2, S1, and S2 in the XYZ coordinate system. A method of calculating the coordinates of the four vertexes T1, T2, S1, and S2 will be described in detail below. The Hogan's plane 40 is an imaginary plane which includes the third line segment 52 and a second line segment 53 serving as the second axis and has four vertexes T1, T2, H1, and H2. In the embodiment, one end of the second line segment 53 is located at the position 61 (origin O) of the head of the golf club 3 as in the first line segment 51, and the second line segment 53 forms a predetermined angle θ (for example, 30 degrees) in the positive direction of the Z axis with respect to the first line segment 51. That is, the second line segment 53 is a line segment that connects the origin O at one end to the position 63 at the other end along a line segment rotated from the first line segment 51 around the X axis by the predetermined angle θ in the positive direction of the Z axis. The length of the second line segment 53 is not particularly limited. For example, the length of the second line segment 53 may be set to be the same as the length of the first line segment 51 or may be obtained according to a predetermined rule using the length of the first line segment 51 as a criterion. Ideally, the predetermined angle θ may be set to differ according to the height of the user 2, the length of an arm, or the like (for example, the position 63 is set to be located at the position of the base of the neck or the position of one of the right and left shoulders of the user 2). In the embodiment, for example, a fixed value appropriate for the length of the average height or arm is used for the purpose of simplifying a calculation process or the like. One end of the second line segment 53 may be located at the position of a ball. Even in this case, the second line segment 53 is defined so that the predetermined angle θ (for example, 30 degrees) is formed in the positive direction of the Z axis with respect to the first line segment 51. The Hogan's plane 40 is specified by calculating the coordinates of the four vertexes T1, T2, H1, and H2 in the XYZ coordinate system. A method of calculating the coordinates of the four vertexes T1, T2, H1, and H2 will be described in detail below.

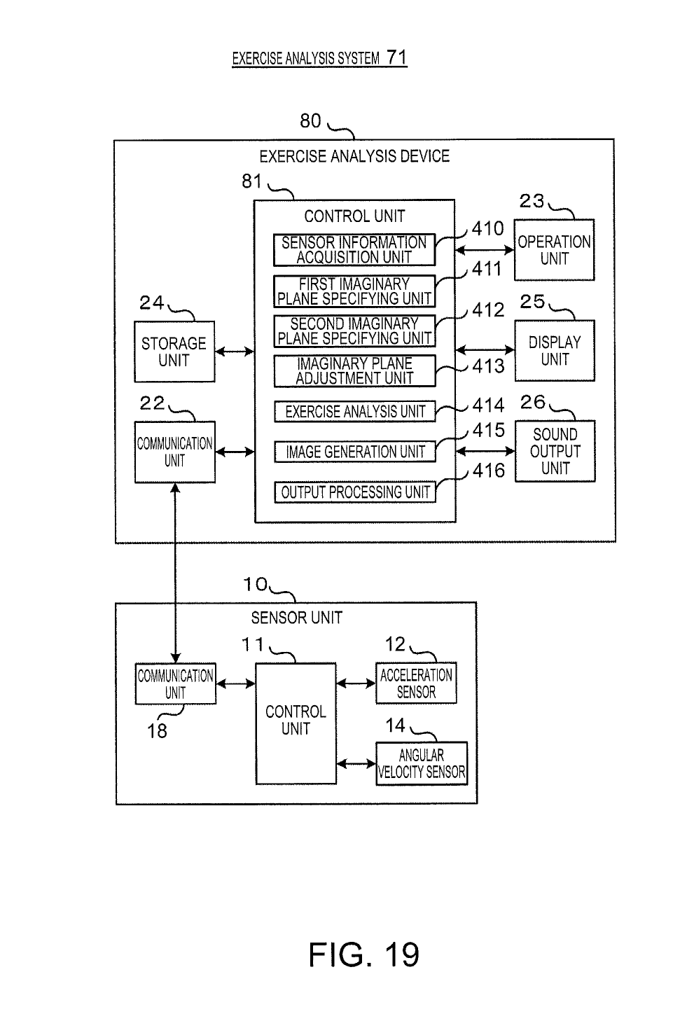

FIG. 19 is a block diagram illustrating an example of the configuration of an exercise analysis system.

The sensor unit 10 includes a control unit 11, a communication unit 18, an acceleration sensor 12, and an angular velocity sensor 14.

The acceleration sensor 12 measures acceleration generated in each of mutually intersecting triaxial directions (ideally, orthogonal to each other) and outputs digital signals (acceleration data) according to the sizes and directions of the measured triaxial accelerations.

The angular velocity sensor 14 measures an angular velocity generated at axis rotation of mutually intersecting triaxial directions (ideally, orthogonal to each other) and outputs digital signals (angular velocity data) according to the sizes and directions of the measured triaxial angular velocities.

The control unit 11 controls the sensor unit in an integrated manner. The control unit 11 receives the acceleration data and the angular velocity data from the acceleration sensor 12 and the angular velocity sensor 14, appends time information, and stores the acceleration data and the angular velocity data in a storage unit (not illustrated). The control unit 11 generates packet data in conformity to a communication format by appending time information to the stored measurement data (the acceleration data and the angular velocity data) and outputs the packet data to the communication unit 18. The acceleration sensor 12 and the angular velocity sensor 14 are ideally fitted in the sensor unit 10 so that the three axes of each sensor match the three axes (the x axis, the y axis, and the z axis) of the rectangular coordinate system (sensor coordinate system) defined for the sensor unit 10, but errors of the fitting angles actually occur. Accordingly, the control unit 11 performs a process of converting the acceleration data and the angular velocity data into data of the xyz coordinate system, using correction parameters calculated in advance according to the errors of the fitting angles.

The control unit 11 may perform a temperature correction process of the acceleration sensor 12 and the angular velocity sensor 14. Alternatively, a temperature correction function may be embedded in the acceleration sensor 12 and the angular velocity sensor 14.

The acceleration sensor 12 and the angular velocity sensor 14 may output analog signals. In this case, the control unit 11 may perform A/D (analog/digital) conversion on each of an output signal of the acceleration sensor 12 and an output signal of the angular velocity sensor 14, generate measurement data (acceleration data and angular velocity data), and generate packet data for communication using the measurement data.

The communication unit 18 performs, for example, a process of transmitting the packet data received from the control unit 11 to the exercise analysis device 80 or a process of receiving control commands from the exercise analysis device 80 and transmitting the control commands to the control unit 11. The control unit 11 performs various processes according to the control commands.

The exercise analysis device 80 includes a control unit 81, a communication unit 22, an operation unit 23, a storage unit 24, a display unit 25, and a sound output unit 261. The communication unit 22 performs, for example, a process of receiving the packet data transmitted from the sensor unit 10 and transmitting the packet data to the control unit 81 or a process of transmitting a control command from the control unit 81 to the sensor unit 10.

The operation unit 23 performs a process of acquiring operation data from the user 2 and transmitting the operation data to the control unit 81. The operation unit 23 may be, for example, a touch panel type display, a button, a key, or a microphone.

The storage unit 24 is configured as, for example, any of various IC memories such as a ROM, a flash ROM, and a RAM or a recording medium such as a hard disk or a memory card.

The storage unit 24 stores, for example, programs used for the control unit 81 to perform various calculation processes or control processes, or various programs or data used for the control unit 81 to realize application functions. In particular, in the embodiment, the storage unit 24 stores an exercise analysis program which is read by the control unit 81 to perform an exercise analysis process. The exercise analysis program may be stored in advance in a nonvolatile recording medium. Alternatively, the exercise analysis program may be received from a server via a network by the control unit 81 and may be stored in the storage unit 24.

In the embodiment, the storage unit 24 stores body information of the user 2, club specification information indicating the specification of the golf club 3, and sensor-mounted position information. For example, when the user 2 operates the operation unit 23 to input the body information such as a height, a weight, and a sex, the input body information is stored as body information in the storage unit 24. For example, the user 2 operates the operation unit 23 to input a model number of the golf club 3 (or selects the model number from a model number list) to be used and sets club specification information regarding the input model number as the specification information among pieces of specification information for each model number (for example, information regarding the length of the shaft, the position of the center of gravity, a lie angle, a face angle, a loft angle, and the like) stored in advance in the storage unit 24. For example, when the user 2 operates the operation unit 23 to input a distance between the position at which the sensor unit 10 is mounted and the grip end of the golf club 3, information regarding the input distance is stored as the sensor-mounted position information in the storage unit 24. Alternatively, by mounting the sensor unit 10 at a decided predetermined position (for example, a distance of 20 cm from the grip end), information regarding the predetermined position may be stored in advance as the sensor-mounted position information.

The storage unit 24 is used as a work area of the control unit 81 and temporarily stores, for example, data input from the operation unit 23 and calculation results performed according to various programs by the control unit 81. The storage unit 24 may store data necessarily stored for a long time among the data generated through the processes of the control unit 81.

The display unit 25 displays a processing result of the control unit 81 as text, a graph, a table, animations, or another image. The display unit 25 may be, for example, a CRT display, an LCD, an electrophoretic display (EPD), a display using an organic light-emitting diode (OLED), a touch panel type display, or a head-mounted display (HMD). The functions of the operation unit 23 and the display unit 25 may be realized by one touch panel type display.

The sound output unit 26 outputs a processing result of the control unit 81 as audio such as a sound or a buzzer tone. The sound output unit 26 may be, for example, a speaker or a buzzer.

The control unit 81 performs a process of transmitting a control command to the sensor unit 10, various calculation processes on data received from the sensor unit 10 via the communication unit 22, and other various control processes according to various programs. In particular, in the embodiment, the control unit 81 executes an exercise analysis program to function as a sensor information acquisition unit 410, a first imaginary plane specifying unit (which corresponds to a first specifying unit according to the invention) 411, a second imaginary plane specifying unit (which corresponds to a second specifying unit according to the invention) 412, an imaginary plane adjustment unit (which corresponds to an adjustment unit according to the invention) 413, an exercise analysis unit 414, an image generation unit 415, and an output processing unit 416. The first and second specifying units may be realized by separate calculation units or may be realized by the same calculation unit.

The control unit 81 may be realized by a computer that includes a central processing unit (CPU) which is a calculation device, a RAM which is a volatile storage device, a ROM which is a non-volatile storage device, an interface (I/F) circuit connecting the control unit 81 to the other units, and a bus mutually connecting these units. The computer may include various dedicated processing circuits such as image processing circuits. The control unit 81 may also be realized by an application specific integrated circuit (ASIC) or the like.

The sensor information acquisition unit 410 receives the packet data received from the sensor unit 10 by the communication unit 22 and acquires the time information and the measurement data from the received packet data. The sensor information acquisition unit 410 stores the acquired time information and measurement data in the storage unit 24 in association therewith.

The first imaginary plane specifying unit 411 performs a process of specifying the first line segment 51 in the major axis direction of the shaft of the golf club 3 at the time of stopping of the user, using the measurement data output by the sensor unit 10. Further, the first imaginary plane specifying unit 411 performs a process of specifying the shaft plane (first imaginary plane) 30 (see FIG. 5) including the first line segment 51 and the third line segment 52 indicating the hitting target direction.

The first imaginary plane specifying unit 411 may calculate the coordinates of the position 62 of the grip end of the golf club 3 using the measurement data output by the sensor unit 10 and specify the first line segment 51 based on the coordinates of the position 62 of the grip end. For example, the first imaginary plane specifying unit 411 may calculate an inclination angle (an inclination relative to the horizontal plane (the XY plane) or the vertical plane (the XZ plane)) of the shaft of the golf club 3, using the acceleration data measured by the acceleration sensor 12 at the time of stopping of the user 2 (the time of the address) and specify the first line segment 51 using the calculated inclination angle and information regarding the length of the shaft included in the club specification information.

The first imaginary plane specifying unit 411 may calculate the width of the shaft plane 30 using the length of an arm of the user 2 based on the body information and the length of the first line segment 51.

The second imaginary plane specifying unit 412 performs a process of specifying the second line segment 53 forming a predetermined angle θ relative to the first line segment 51 specified by the first imaginary plane specifying unit 411, using the hitting target direction (the third line segment 52) as the rotation axis. As described above, for example, the second line segment 53 is the line segment that connects the position 63 to the position 61 of the head (blow portion) of the golf club 3. Further, the second imaginary plane specifying unit 412 performs a process of specifying the Hogan's plane (second imaginary plane) 40 (see FIG. 5) including the second line segment 53 and the third line segment 52.

The second imaginary plane specifying unit 412 may calculate the width of the Hogan's plane 40 using the length of the arm of the user 2 based on the length of the first line segment 51 and the body information.

The imaginary plane adjustment unit 413 determines whether the angle of the second line segment 53 (an angle with respect to the horizontal plane) is greater than a predetermined upper limit angle (which corresponds to a threshold angle according to the invention and is, for example, 90 degrees), and adjusts the angle of the second line segment 53 so that the angle of the second line segment 53 is equal to or less than the predetermined upper limit angle when the angle is greater than the predetermined upper limit angle. In the embodiment, the angle (the angle of the Hogan's plane) of the second line segment 53 serving as the second axis is decided by adding the predetermined angle θ using the angle (the angle of the shaft plane) of the first line segment 51 serving as the first axis as a criterion. Therefore, depending on the angle of the first line segment 51, the angle of the second line segment 53 is greater than the predetermined upper limit angle in some cases. In general, since the angle of the Hogan's plane 40 is rarely assumed to be greater than 90 degrees, the above-described adjustment is performed in the embodiment.

The exercise analysis unit 414 performs a process of analyzing a swing exercise of the user 2 using the measurement data output by the sensor unit 10. Specifically, the exercise analysis unit 414 first calculates an offset amount included in the measurement data using the measurement data (the acceleration data and the angular velocity data) at the time of stopping of the user 2 (the time of the address), which is stored in the storage unit 24. Next, the exercise analysis unit 414 subtracts the offset amount from the measurement data after start of a swing, which is stored in the storage unit 24 to correct a bias and calculates the position and posture of the sensor unit 10 during a swing motion of the user 2 using the measurement data in which the bias is corrected.

For example, the exercise analysis unit 414 calculates the position (initial position) of the sensor unit 10 at the time of stopping of the user 2 (the time of the address) in the XYZ coordinate system (global coordinate system), using the acceleration data measured by the acceleration sensor 12, the club specification information, and the sensor-mounted position information, integrates the subsequent acceleration data, and chronologically calculates a change in the position of the sensor unit 10 from the initial position. Since the user 2 stops at a predetermined address posture, the X coordinate of the initial position of the sensor unit 10 is 0. Further, the y axis of the sensor unit 10 is identical to the major axis direction of the shaft of the golf club 3, and the acceleration sensor 12 measures only the gravity acceleration at the time of stopping of the user 2. Therefore, the exercise analysis unit 414 can calculate an inclination angle of the shaft (an inclination relative to the horizontal plane (the XY plane) or the vertical plane (the XZ plane)), using y-axis acceleration data. Then, the exercise analysis unit 414 can calculate the Y and Z coordinates of the initial position of the sensor unit 10 using the inclination angle of the shaft, the club specification information (the length of the shaft), and the sensor-mounted position information (the distance from the grip end) and specify the initial position of the sensor unit 10. Alternatively, the exercise analysis unit 414 may calculate the coordinates of the initial position of the sensor unit 10 using the coordinates of the position 62 of the grip end of the golf club 3 calculated by the first imaginary plane specifying unit 411 and the sensor-mounted position information (the distance from the grip end).

The exercise analysis unit 414 calculates the posture (initial posture) of the sensor unit 10 at the time of stopping of the user 2 (the time of the address) in the XYZ coordinate system (global coordinate system), using the acceleration data measured by the acceleration sensor 12, performs rotation calculation using the angular velocity data measured subsequently by the angular velocity sensor 14, and chronologically calculates a change in the posture from the initial posture of the sensor unit 10. The posture of the sensor unit 10 can be expressed by, for example, rotation angles (a roll angle, a pitch angle, and a yaw angle) around the X axis, the Y axis, and the Z axis, Eulerian angles, quaternions, or the like. At the time of stopping of the user 2, the acceleration sensor 12 measures only the gravity acceleration. Therefore, the exercise analysis unit 414 can specify an angle formed between of each of the x, y, and z axes of the sensor unit 10 and a gravity direction using triaxial acceleration data. Since the user 2 stops at the predetermined address posture, the y axis of the sensor unit 10 is present on the YZ plane at the time of stopping of the user 2. The exercise analysis unit 414 can specify the initial posture of the sensor unit 10.

The control unit 11 of the sensor unit 10 may calculate the offset amount of the measurement data and correct the bias of the measurement data or a bias correction function may be embedded in the acceleration sensor 12 and the angular velocity sensor 14. In this case, it is not necessary to correct the bias of the measurement data by the exercise analysis unit 414.

The exercise analysis unit 414 defines an exercise analysis model (a double pendulum model or the like) in consideration of the body information (the height (length of the arm) of the user 2), the club specification information (the length or the position of the center of the shaft), the senor-mounted position information (the distance from the grip end), features (rigid body and the like) of the golf club 3, and features of a human body (for example, a joint bending direction is decided), and then calculates a trajectory of the golf club 3 at a swing of the user 2 using the exercise analysis model and the information regarding the position and posture of the sensor unit 10.

The exercise analysis unit 414 detects a series of motions (also referred to as a “rhythm”) from start to end of a swing of the user 2, for example, start of a swing, a backswing, a top, a downswing, an impact, follow-through, and end of the swing, using time information and the measurement data stored in the storage unit 24. For example, the exercise analysis unit 414 calculates a composite value of the measurement data (the acceleration data or the angular velocity data) output by the sensor unit 10 and specifies a timing (time) of an impact by the user 2 based on the composite value.

Using the exercise analysis model and information regarding the position and posture of the sensor unit 10, the exercise analysis unit 414 may generate a rhythm of a swing from a backswing to follow-through, a head speed, an incident angle (club pass) or a face angle at the time of hitting, shaft rotation (a change amount of face angle during a swing), information regarding a deceleration rate or the like of the golf club 3, or information regarding a variation in each piece of information when the user 2 performs the swing a plurality of times.

The image generation unit 415 performs a process of generating image data corresponding to an image of an exercise analysis result displayed on the display unit 25. In particular, in the embodiment, the image generation unit 415 generates image data including the shaft plane 30 specified by the first imaginary plane specifying unit 411, the Hogan's plane 40 specified by the second imaginary plane specifying unit 412, and the trajectory of the golf club 3 at a swing (in particular, a downswing) of the user 2, which is calculated by the exercise analysis unit 414. For example, the image generation unit 415 generates polygon data of the shaft plane 30 having the four vertexes T1, T2, S1, and S2 illustrated in FIG. 5 based on information regarding the coordinates of T1, T2, S1, and S2 and generates polygon data of the Hogan's plane 40 having the four vertexes T1, T2, H1, and H2 based on information regarding the coordinates of T1, T2, H1, and H2. The image generation unit 415 generates curved-line data indicating the trajectory of the golf club 3 at the time of a downswing of the user 2. Then, the image generation unit 415 generates image data including the polygon data of the shaft plane 30, the polygon data of the Hogan's plane 40, and the curved-line data indicating the trajectory of the golf club 3.

The first imaginary plane specifying unit 411, the second imaginary plane specifying unit 412, the imaginary plane adjustment unit 413, the exercise analysis unit 414, and the image generation unit 415 also perform a process of storing various kinds of calculated information in the storage unit 24.

The output processing unit 416 performs a process of causing the display unit 25 to display various images (including not only an image corresponding to the image data generated by the image generation unit 415 but also text or signs). For example, the output processing unit 416 causes the display unit 25 to display the image corresponding to the image data generated by the image generation unit 415 automatically or according to an input operation of the user 2 after a swing motion of the user 2 ends. Alternatively, the sensor unit 10 may include a display unit, the output processing unit 416 may transmit the image data to the sensor unit 10 via the communication unit 22, and various images may be displayed on the display unit of the sensor unit 10.

The output processing unit 416 performs a process of causing the sound output unit 26 to output various kinds of audio (also including sound or buzzer tone). For example, the output processing unit 416 reads various kinds of information stored in the storage unit 24 and causes the sound output unit 26 to output audio or sound for exercise analysis automatically or at the time of performing a predetermined input operation after a swing motion of the user 2 ends. Alternatively, the sensor unit 10 may include an sound output unit, the output processing unit 416 may transmit various kinds of audio data or sound data to the sensor unit 10 via the communication unit 22, and the sound output unit of the sensor unit 10 may be caused to output the various kinds of audio or sound.

The exercise analysis device 80 or the sensor unit 10 may include a vibration mechanism and various kinds of information may be converted into vibration information by the vibration mechanism to be presented to the user 2.

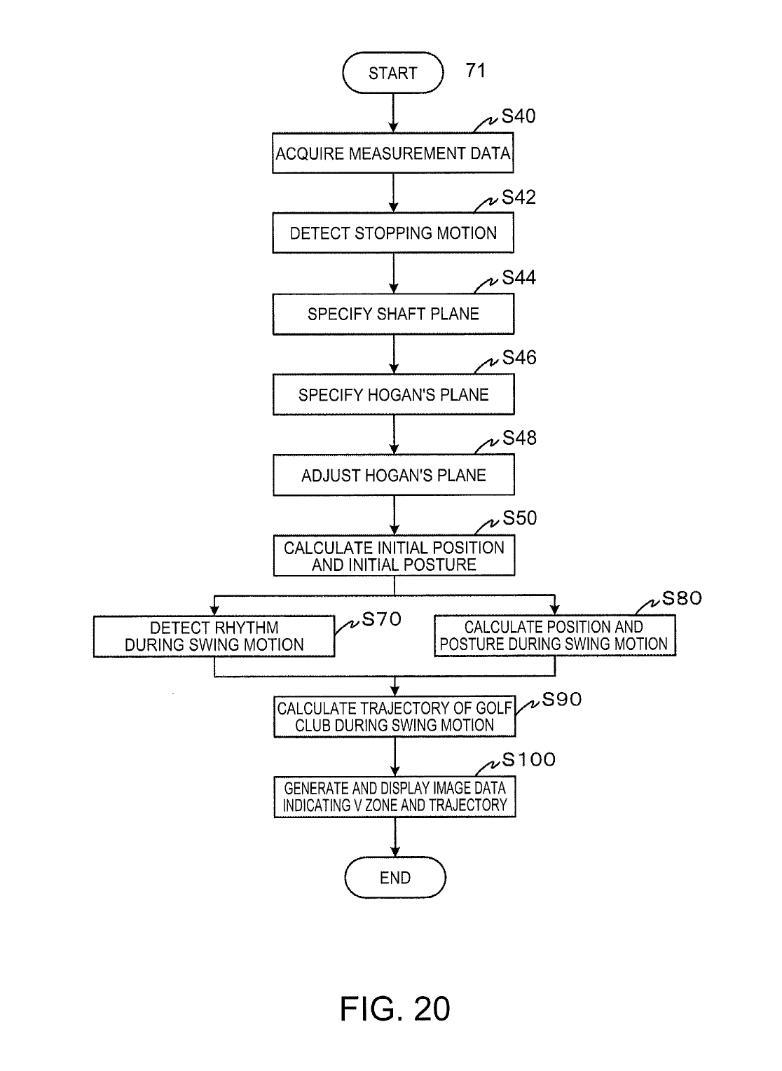

FIG. 20 is a flowchart illustrating an example of an exercise analysis process. The control unit 81 executes an exercise analysis program stored in the storage unit 24 to perform the exercise analysis process in the procedure of the flowchart illustrated in FIG. 20.

First, the sensor information acquisition unit 410 acquires the measurement data of the sensor unit 10 (step S40). When the control unit 81 acquires the first measurement data in a swing motion (also including a stopping motion) of the user 2, the control unit 81 may perform processes subsequent to step S42 in real time. Alternatively, after the control unit 81 acquires some or all of the series of measurement data in the swing motion of the user 2 from the sensor unit 10, the control unit 81 may perform the processes subsequent to step S42.

Next, the exercise analysis unit 414 detects a stopping motion (address motion) of the user 2 using the measurement data acquired from the sensor unit 10 (step S42). When the control unit 81 performs the process in real time and detects the stopping motion (address motion), for example, the control unit 81 outputs a predetermined image or audio. Alternatively, the sensor unit 10 may include a light-emitting unit such as a light emitting diode (LED) and blinks the light-emitting unit to notify the user 2 that the stopped state is detected so that the user 2 confirms the notification and subsequently starts a swing.

Next, the first imaginary plane specifying unit 411 specifies the shaft plane 30 (the first imaginary plane) using the measurement data (the measurement data in the stopping motion (address motion) of the user 2) acquired from the sensor unit 10 and the club specification information (step S44).

Next, the second imaginary plane specifying unit 412 specifies the Hogan's plane 40 (the second imaginary plane) based on the shaft plane 30 (the first imaginary plane) specified by the first imaginary plane specifying unit 411 (step S46).

Next, the imaginary plane adjustment unit 413 determines whether the angle of the Hogan's plane specified by the second imaginary plane specifying unit 412 is greater than the predetermined upper limit angle and adjusts the angle of the Hogan's plane or the angles of the shaft plane and the Hogan's plane when the angle of the Hogan's plane is greater than the predetermined upper limit angle (step S48).

Next, the exercise analysis unit 414 calculates the initial position and the initial posture of the sensor unit 10 using the measurement data (the measurement data in the stopping motion (address motion) of the user 2) acquired from the sensor unit 10 (step S50).

Next, the exercise analysis unit 414 detects a series of motions (rhythm) from the start of the swing to the end of the swing using the measurement data acquired from the sensor unit 10 (step S70).

The exercise analysis unit 414 calculates the position and posture of the sensor unit 10 during the swing motion of the user 2 concurrently with the process of step S70 (step S80).

Next, the exercise analysis unit 414 calculates the trajectory of the golf club 3 during the swing motion of the user 2 using the rhythm detected in step S70 and the position and posture of the sensor unit 10 calculated in step S80 (step S90).

Next, the image generation unit 415 generates the image data including the shaft plane specified in step S44 or adjusted in step S48 and the Hogan's plane specified in step S46 or adjusted in step S48, and the trajectory of the golf club calculated in step S90 during the swing motion, and then the output processing unit 416 causes the display unit 25 to display the image data (step S100). Then, the control unit 81 ends the processes of the flowchart illustrated in FIG. 20.

In the flowchart of FIG. 20, the sequence of the processes may be appropriately changed within a possible range.

Next, an example of the process (the process of step S44 in FIG. 20) of specifying the shaft plane (the first imaginary plane) will be described in detail.

As illustrated in FIG. 5, the first imaginary plane specifying unit 411 first calculates the coordinates (0, GY, GZ) of the position 62 of the grip end based on the acceleration data at the time of the stopping measured by the sensor unit 10 and the club specification information by using the position 61 of the head of the golf club 3 as the origin O (0, 0, 0) of the XYZ coordinate system (global coordinate system). As illustrated in FIG. 5, the position 61 of the head of the golf club 3 is the origin O (0, 0, 0) and the coordinates of the position 62 of the grip end are (0, GY, GZ). Since the gravity acceleration G is applied to the sensor unit 10 at the time of stopping of the user 2, a relation between the y axis acceleration y(0) and an inclination angle (an angle formed by the major axis of the shaft and the horizontal plane (XY plane)) α of the shaft of the golf club 3 is expressed in equation (17).

y(0)=G·sin α (17)

Accordingly, when L1 is the length of the shaft of the golf club 3 included in the club specification information, GY and GZ are calculated using the length L1 and the inclination angle α of the shaft in equations (18) and (19), respectively.

G_{Y}=L₁·cos α (18)

G_{Z}=L₁·sin α (19)

Next, the first imaginary plane specifying unit 411 multiplies the coordinates (0, GY, GZ) of the position 62 of the grip end of the golf club 3 by a scale factor S to calculate the coordinates (0, SY, SZ) of a midpoint S3 of the vertexes S1 and S2 of the shaft plane 30. That is, SY and SZ are calculated using equations (20) and (21).

S_{Y}=G_{Y}·S (20)

S_{Z}=G_{Z}·S (21)

As illustrated in FIG. 12, the length (the width of the shaft plane 30 in a direction perpendicular to the X axis) of a line segment connecting the origin O to the midpoint S3 of the vertexes S1 and S2 is S times the length L1 of the first line segment 51. The scale factor S is set to a value so that the trajectory of the golf club 3 during the swing motion of the user 2 falls within the shaft plane 30. For example, when L2 is the length of an arm of the user 2, the scale factor S may be set as in equation (22) so that a width S×L1 in the direction perpendicular to the X axis of the shaft plane 30 is twice a sum of the length L1 of the shaft and the length L2 of the arm.

$$S = \frac{2 \cdot ( {L}_{1} + {L}_{2} )}{{L}_{1}} \qquad ( 22 )$$

The length L2 of the arm of the user 2 has correlation with a height L0 of the user 2. For example, based on statistical information, a correlation equation as in equation (23) is expressed when the user 2 is male, and a correlation equation as in equation (24) is expressed when the user 2 is female.

L₂=0.41×L₀−45.5[mm] (23)

L₂=0.46×L₀−126.9[mm] (24)

Accordingly, the length L2 of the arm of the user is calculated by equation (23) or (24) using the height L0 and sex of the user 2 included in the body information.

Next, the first imaginary plane specifying unit 411 calculates the coordinates (−TL/2, 0, 0) of the vertex T1, the coordinates (TL/2, 0, 0) of the vertex T2, the coordinates (−TL/2, SY, SZ) of the vertex S1, and the coordinates (TL/2, SY, SZ) of the vertex S2 of the shaft plane 30 using the coordinates (0, SY, SZ) of the midpoint S3 calculated as described above and the width (the length of the third line segment 52) TL of the shaft plane 30 in the X axis direction. The width TL in the X axis direction is set to a value so that the trajectory of the golf club 3 during the swing motion of the user 2 falls within the shaft plane 30. For example, the width TL in the X axis direction may be set to be the same as the width S×L1 in the direction perpendicular to the X axis, that is, twice the sum of the length L1 of the shaft and the length L2 of the arm.

The shaft plane 30 is specified based on the coordinates of the four vertexes T1, T2, S1, and S2 calculated in this way.

Next, an example of the process (the process of step S46 in FIG. 20) of specifying the Hogan's plane (the second imaginary plane) will be described in detail.

First, the second imaginary plane specifying unit 412 calculates the coordinates (AX, AY, AZ) of the position 63 using the coordinates (0, GY, GZ) of the position 62 of the grip end of the golf club 3 calculated as described above and the predetermined angle θ.

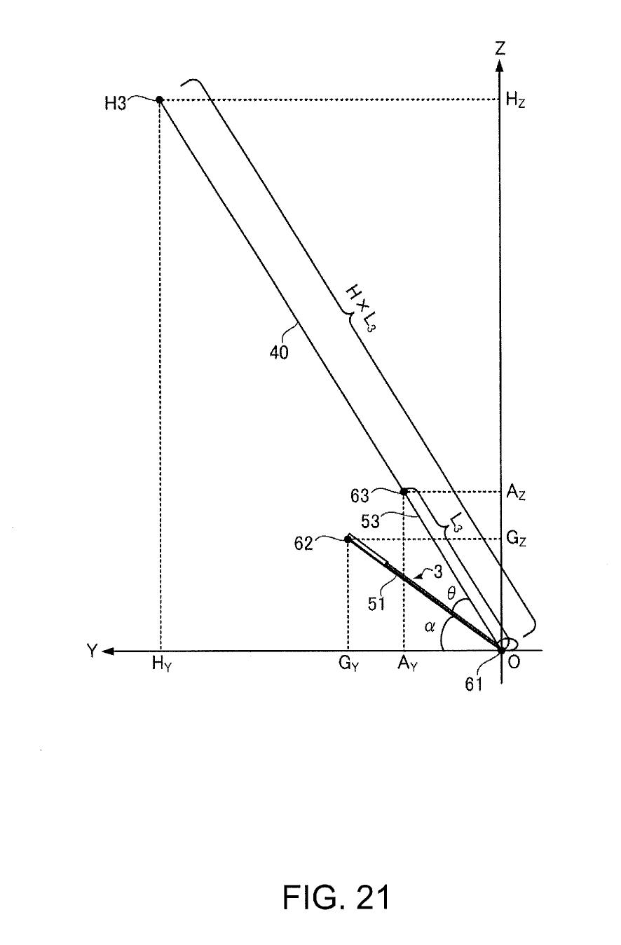

FIG. 21 is a diagram illustrating a cross section obtained by cutting the Hogan's plane 40 in FIG. 5 along the YZ plane when viewed from the negative side of the X axis. In FIG. 21, the predetermined position 63 is present on the YZ plane. Accordingly, the X coordinate AX of the predetermined position 63 is 0. Then, the second imaginary plane specifying unit 412 sets the first line segment 51 as a rotation axis, performs rotation by the predetermined angle θ in the positive direction of the Z axis, and specifies the inclination of the second line segment 53. Here, the length of the second line segment 53 is set to be the same as the length of the first line segment 51. The second imaginary plane specifying unit 412 specifies the end of a line segment extending with the inclination and the length specified in the above-described manner from the origin O as the position 63 and specifies the Y coordinate AY and the Z coordinate AZ of the position 63. In this way, the second line segment 53 connecting the origin O to the position 63 is specified.

Next, the second imaginary plane specifying unit 412 multiples the Y coordinate AY and the Z coordinate AZ of the position 63 by a scale factor H to calculate the coordinates (0, HY, HZ) of a midpoint H3 of the vertexes H1 and H2 of the Hogan's plane 40. That is, HY and HZ are calculated using equations (25) and (26).

H_{Y}=A_{Y}·H (25)

H_{Z}=A_{Z}·H (26)

As illustrated in FIG. 21, a length (a width of the Hogan's plane 40 in a direction perpendicular to the X axis) of a line segment connecting the origin O to the midpoint H3 of the vertexes H1 and H2 is H times the length L3 of the second line segment 53. The scale factor H is set to a value so that the trajectory of the golf club 3 during the swing motion of the user 2 falls within the Hogan's plane 40. For example, the Hogan's plane 40 may have the same shape and size as the shaft plane 30. In this case, since a width H×L3 of the Hogan's plane 40 in the direction perpendicular to the X axis is identical to the width S×L1 of the shaft plane 30 in the direction perpendicular to the X axis and is twice the sum of the length L1 of the shaft of the golf club 3 and the length L2 of the arm of the user 2, the scale factor H may be set as in equation (27).

$$H = \frac{2 \cdot ( {L}_{1} + {L}_{2} )}{{L}_{3}} \qquad ( 27 )$$

The length L3 of the second line segment 53 is calculated from equation (28) using the Y coordinate AY and the Z coordinate AZ of the predetermined position 63.

L₃=\sqrt{A_{Y}²+A_{Z}²} (28)

Next, the second imaginary plane specifying unit 412 calculates the coordinates (−TL/2, 0, 0) of the vertex T1, the coordinates (TL/2, 0, 0) of the vertex T2, the coordinates (−TL/2, HY, HZ) of the vertex H1, and the coordinates (TL/2, HY, HZ) of the vertex H2 of the Hogan's plane 40 using the coordinates (0, HY, HZ) of the midpoint H3 calculated as described above and the width (the length of the third line segment 52) TL of the Hogan's plane 40 in the X axis direction. The width TL in the X axis direction is set to a value so that the trajectory of the golf club 3 during the swing motion of the user 2 falls within the Hogan's plane 40. In the embodiment, for example, the width TL of the Hogan's plane 40 in the X axis direction may be set to be the same as the width of the shaft plane 30 in the X axis direction, and thus may be set to be twice the sum of the length L1 of the shaft and the length L2 of the arm, as described above.

The Hogan's plane 40 is specified based on the coordinates of the four vertexes T1, T2, H1, and H2 calculated in this way.

Next, an example of the process (the process of step S48 of FIG. 20) of adjusting the angle of the Hogan's plane (second imaginary plane) will be described in detail.

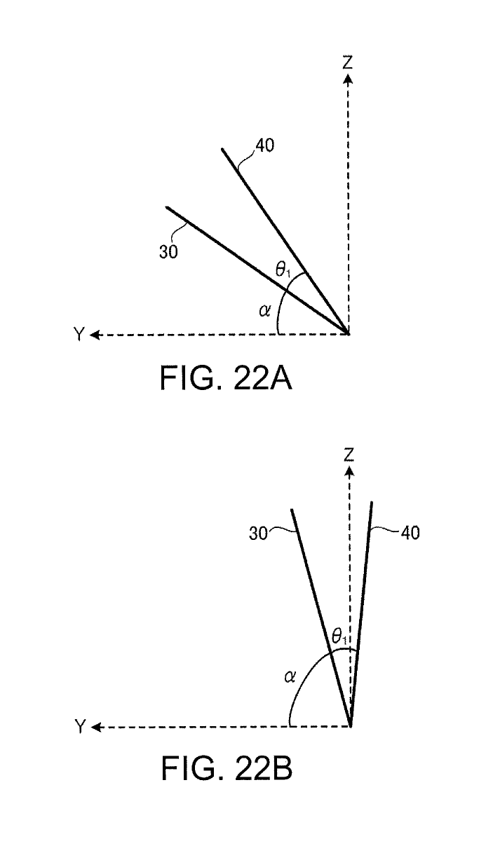

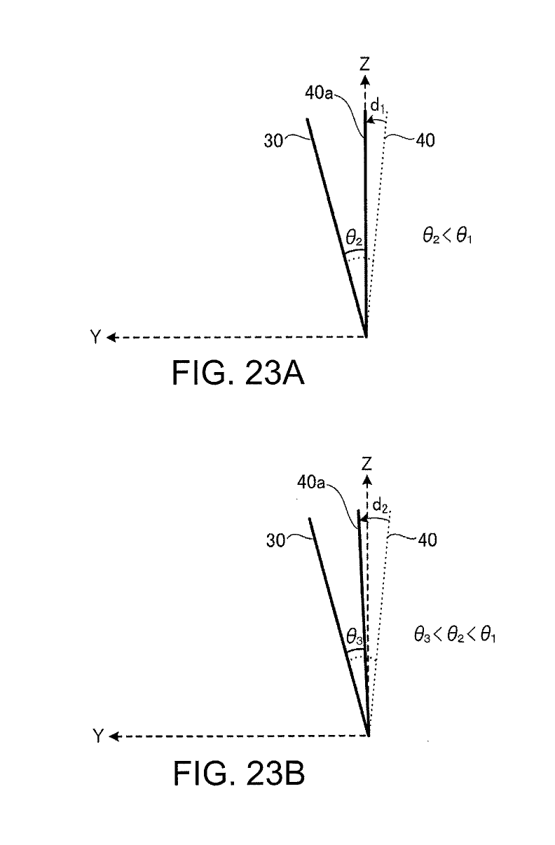

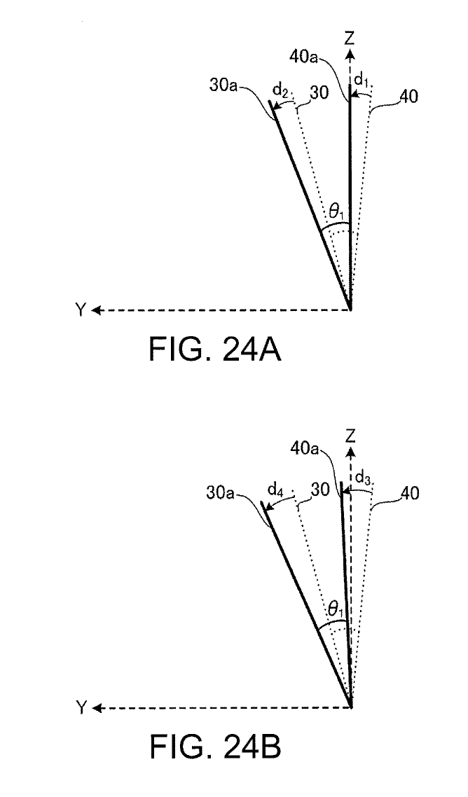

FIG. 22A is a diagram illustrating an example when the Hogan's plane does not exceed the predetermined upper limit angle. FIG. 22B is a diagram illustrating an example when the Hogan's plane exceeds a predetermined upper limit angle. FIGS. 23A, 23B, 24A, and 24B are diagrams illustrating an example of an adjustment procedure so that the Hogan's plane does not exceed the predetermined upper limit angle. FIGS. 22A, 22B, 23A, 23B, 24A, and 24B are diagrams illustrating cross sections obtained by cutting the shaft plane 30 and the Hogan's plane 40 in FIG. 5 along the YZ plane when viewed from the negative side of the X axis. In FIGS. 22A, 22B, 23A, 23B, 24A, and 24B, an angle formed by the shaft plane 30 and the Hogan's plane 40 before adjustment is assumed to be θ1, and an angle formed by a shaft plane 30a and a Hogan's plane 40a after the adjustment is θ2 or θ3. In FIGS. 22A, 22B, 23A, 23B, 24A, and 24B, the predetermined upper limit angle is assumed to be 90 degrees (which is identical to the Z axis in the drawings).

As illustrated in FIG. 22A, when the angle (α+θ1) of the Hogan's plane 40 specified in step S46 does not exceed 90 degrees, the imaginary plane adjustment unit 413 does not adjust the Hogan's plane 40. As illustrated in FIG. 22B, conversely, when the angle (α+θ1) of the Hogan's plane 40 specified in step S46 exceeds 90 degrees, the imaginary plane adjustment unit 413 adjusts the angle of the Hogan's plane 40 or the angles of the shaft plane 30 and the Hogan's plane 40, as will be described below.

In the example of FIG. 23A, the imaginary plane adjustment unit 413 changes the angle of the Hogan's plane 40 to 90 degrees to set the Hogan's plane 40a. In this case, the angle of the Hogan's plane 40a is α+θ2=90 degrees, an adjustment amount which is a difference between the angles of the Hogan's plane before and after the adjustment is d1, and θ2<θ1 is satisfied. In this way, it is possible to appropriately adjust the angle of the Hogan's plane exceeding 90 degrees which may not generally be assumed.

In the example of FIG. 23B, the imaginary plane adjustment unit 413 changes the angle of the Hogan's plane 40 to an angle less than 90 degrees (and greater than the angle of the shaft plane 30) to set the Hogan's plane 40a. In this case, the angle of the Hogan's plane 40a is α+θ3<90 degrees, the adjustment amount which is a difference between the angles of the Hogan's plane before and after the adjustment is d2>d1, and θ3<θ2<θ1 is satisfied. In this way, it is possible to appropriately adjust the angle of the Hogan's plane exceeding 90 degrees which may not generally be assumed.

For example, whether to use the adjustment amount d1 or the adjust amount d2 may be set through the operation unit 23 by the user 2. In this way, it is possible to flexibly set the area of the V zone according to a type of swing of the user 2, a habit of a swing, the specification of the club to be used, and the like.

Here, for example, the imaginary plane adjustment unit 413 may receive a designation of the type of club (for example, an iron or a putter) used in a swing through the operation unit 23 from the user 2 and decide the adjustment amount of the Hogan's plane 40 to d1 or d2 according to the designated type of club (for example, d1 is selected when a putter is designated and d2 is selected when an iron is designated). For example, the imaginary plane adjustment unit 413 may receive a designation of the type of club (for example, an iron and the model number of the iron or a putter) used in a swing through the operation unit 23 from the user 2 and decide the adjustment amount of the Hogan's plane 40 to d1 or d2 step by step according to the designated type of club (for example, d1 is selected when a putter is designated, number d1-1 is selected when a number 9 iron is designated, and number d1-2 is selected when number 8 iron is designated). In this way, it is possible to more appropriately adjust the angle of the Hogan's plane exceeding 90 degrees which may not generally be assumed according to the club.

In the example of FIG. 24A, the imaginary plane adjustment unit 413 changes the angle of the Hogan's plane 40 to 90 degrees to set the Hogan's plane 40a and changes the angle of the shaft plane 30 specified in step S44 (rotates on the opposite side to the Hogan's plane 40) to set the shaft plane 30a. At this time, the imaginary plane adjustment unit 413 sets the Hogan's plane 40a and the shaft plane 30a while maintaining the angle θ1 constantly. In this case, the adjustment amount d1 which is a difference between the angles of the Hogan's plane before and after the adjustment is the same as the adjustment amount d2 which is a difference between the angles of the shaft plane before and after the adjustment. The angle of the Hogan's plane 40a is “α+θ1−d1=90 degrees” and the angle of the shaft plane 30a is “α−d2.” In this way, it is possible to appropriately adjust the angle of the Hogan's plane exceeding 90 degrees which may not generally be assumed without narrowing the range of the V zone.

In the example of FIG. 24B, the imaginary plane adjustment unit 413 changes the angle of the Hogan's plane 40 to an angle less than 90 degrees (and greater than the angle of the shaft plane 30), sets the Hogan's plane 40a, changes the angle of the shaft plane 30 specified in step S44 (rotates on the opposite side to the Hogan's plane 40) to be small, and sets the shaft plane 30a. At this time, the imaginary plane adjustment unit 413 sets the Hogan's plane 40a and the shaft plane 30a while maintaining the angle θ1 constantly. In this case, the adjustment amount d3 which is a difference between the angles of the Hogan's plane before and after the adjustment is the same as the adjustment amount d4 which is a difference between the angles of the shaft plane before and after the adjustment. Further, “d1=d2<d3=d4” is satisfied, the angle of the Hogan's plane 40a is “α+θ1−d3<90 degrees” and the angle of the shaft plane 30a is “α−d4.” In this way, it is possible to appropriately adjust the angle of the Hogan's plane exceeding 90 degrees which may not generally be assumed without narrowing the range of the V zone.

For example, whether to use the adjustment amounts d1 and the adjust amount d2 or the adjustment amounts d3 and d4 may be set through the operation unit 23 by the user 2. In this way, it is possible to flexibly set the inclination degree of the V zone according to a type of swing of the user 2, a habit of a swing, the specification of the club to be used, and the like.

Here, for example, the imaginary plane adjustment unit 413 may receive a designation of the type of club (for example, an iron or a putter) used in a swing through the operation unit 23 from the user 2 and decide the adjustment amounts of the Hogan's plane 40 and the shaft plane 30 to d1 and d2 or d3 and d4 according to the designated type of club (for example, d1 and d2 are selected when a putter is designated and d3 and d4 are selected when an iron is designated). For example, the imaginary plane adjustment unit 413 may receive a designation of the type of club (for example, an iron and the model number of the iron or a putter) used in a swing through the operation unit 23 from the user 2 and decide the adjustment amounts of the Hogan's plane 40 and the shaft plane 30 step by step according to the designated type of club (for example, numbers d1 and d2 are selected when a putter is designated, numbers d1-1 and d2-1 are selected when a number 9 iron is designated, and numbers d1-2 and d2-2 are selected when a number 8 iron is designated). In this way, it is possible to more appropriately adjust the angle of the Hogan's plane exceeding 90 degrees which may not generally be assumed according to the club without narrowing the range of the V zone.

The adjustment amounts may be decided according to the designated club specification information (for example, information regarding the length of the shaft, the position of the center of gravity, a lie angle, a face angle, a loft angle, and the like) without deciding the adjustment amounts according to the type of club. The adjustment amounts may be decided according to designated body information (for example, the length of an arm, the height, or the like) of the user. The user may set the values of the adjustment amounts.

As described above, the imaginary plane adjustment unit 413 adjusts the Hogan's plane or the Hogan's plane and the shaft plane and calculates the coordinates T1, T2, H1, and H2 of the Hogan's plane after the adjustment and the coordinates T1, T2, S1, and S2 of the shaft plane after the adjustment.

Next, an example of the process (the process of step S70 in FIG. 20) of detecting a series of motions (rhythm) from the start of the swing to the end of the swing of the user 2 will be described in detail.

The exercise analysis unit 414 detects a series of motions (rhythm) from the start of the swing to the end of the swing, for example, the start of the swing, a backswing, a top, a downswing, an impact, follow-through, and the end of the swing, using the measurement data acquired from the sensor unit 10. A specific rhythm detection procedure is not particularly limited. For example, the following procedure can be adopted.

First, the exercise analysis unit 414 calculates a sum (referred to as a composite value or a norm) of the magnitudes of the angular velocities around the axes at each time t using the acquired angular velocity data of each time t. The exercise analysis unit 414 may differentiate the norm of the angular velocities at each time t by time.

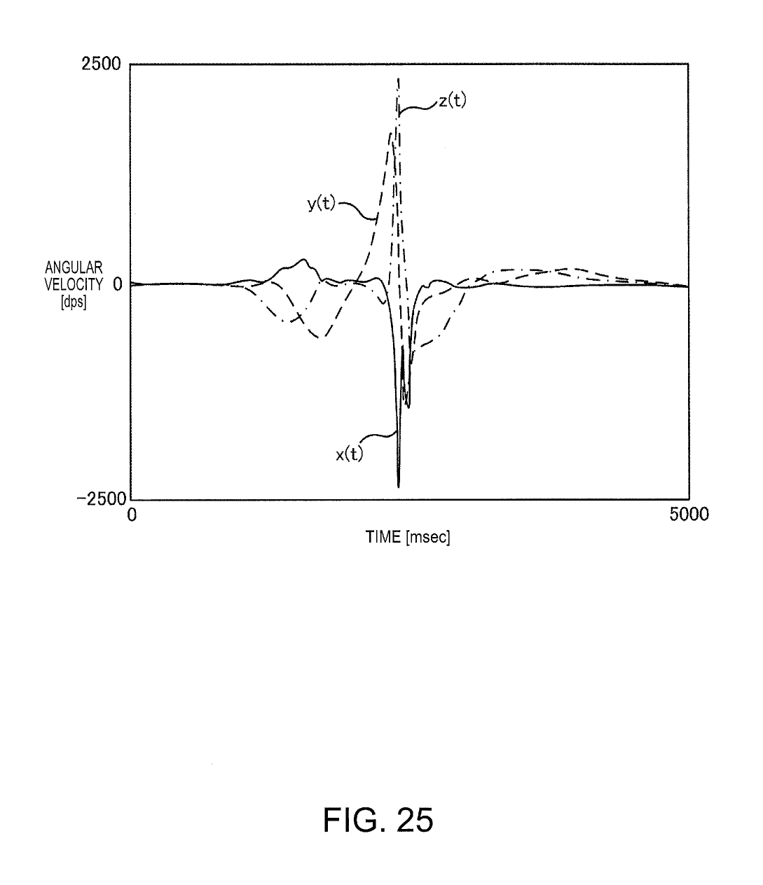

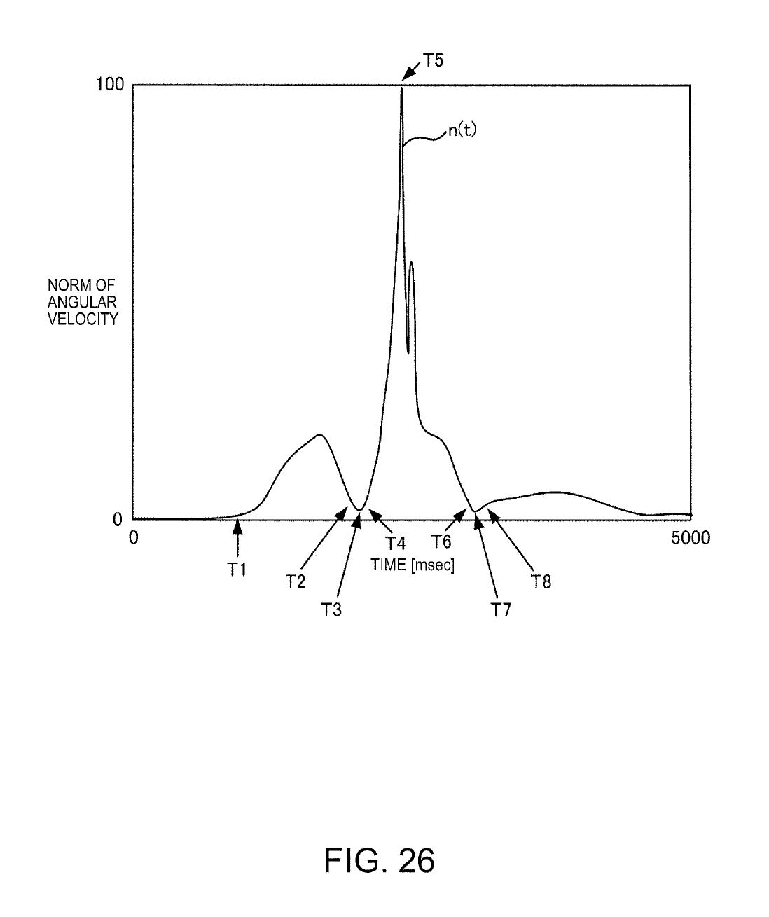

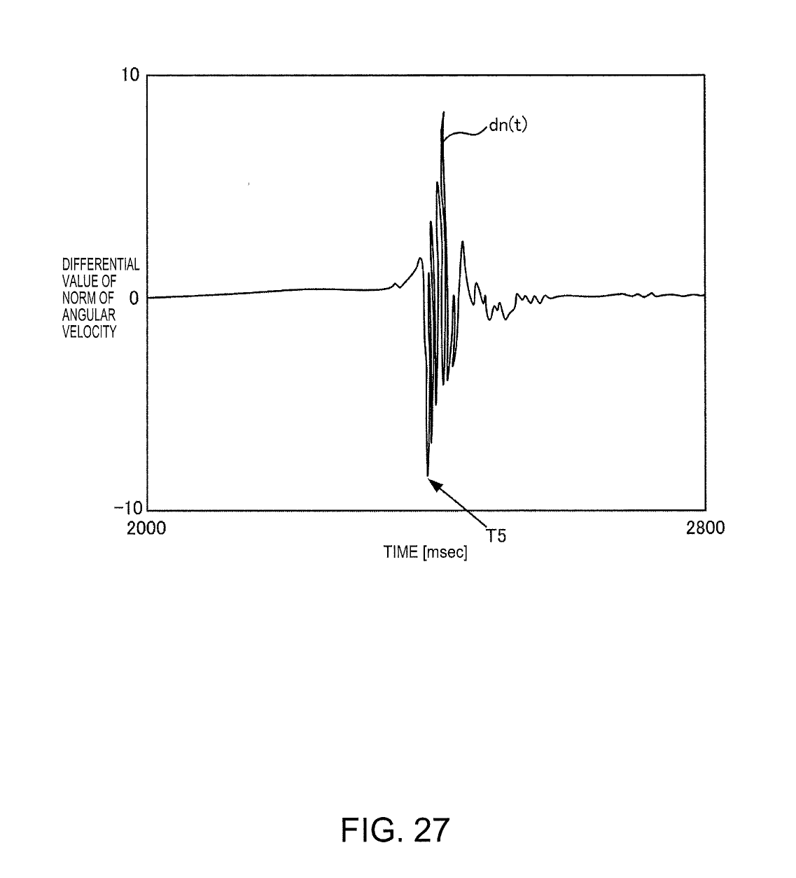

Here, a case of a graph in which angular velocities around three axes (x, y, and z axes) are shown, for example, in FIG. 25 (which is a diagram illustrating examples of angular velocities output from the sensor unit) will be considered. In FIG. 25, the horizontal axis represents a time (msec) and the vertical axis represents an angular velocity (dps). The norm of the angular velocities is shown in the graph illustrated in, for example, FIG. 26 (which is a diagram illustrating an example of the norm of the angular velocities). In FIG. 26, the horizontal axis represents a time (msec) and the vertical axis represents the norm of the angular velocities. A differential value of the norm of the angular velocity is shown in a graph illustrated in, for example, FIG. 27 (which is a diagram illustrating an example of the differential value of the norm of the angular velocity). In FIG. 27, the horizontal axis represents a time (msec) and the vertical axis represents the differential value of the norm of the angular velocities. FIGS. 25 to 27 are exemplified to facilitate understanding of the embodiment and do not show accurate values.

The exercise analysis unit 414 detects a timing of an impact in the swing using the calculated norm of the angular velocities. For example, the exercise analysis unit 414 detects a timing at which the norm of the angular velocities is the maximum as the timing of the impact (T5 in FIG. 26). For example, the exercise analysis unit 414 may detect a former timing between timings at which the differential value of the calculated norm of the angular velocities is the maximum and the minimum as the timing of the impact (T5 in FIG. 27).

For example, the exercise analysis unit 414 detects a timing at which the calculated norm of the angular velocities is the minimum before the impact as a timing of a top of the swing (T3 in FIG. 26). For example, the exercise analysis unit 414 specifies a period in which the norm of the angular velocities is continuously equal to or less than a first threshold value before the impact, as a top period (which is an accumulation period at the top) (T2 to T4 in FIG. 26).

For example, the exercise analysis unit 414 detects a timing at which the norm of the angular velocities is equal to or less than a second threshold value before the top, as a timing of the start of the swing (T1 in FIG. 26).

For example, the exercise analysis unit 414 detects a timing at which the norm of the angular velocities is the minimum after the impact, as a timing of the end (finish) of the swing (T7 in FIG. 26). For example, the exercise analysis unit 414 may detect a timing at which the norm of the angular velocities is first equal to or less than the third threshold value after the impact, as the timing of the end (finish) of the swing. For example, the exercise analysis unit 414 specifies a period in which the norm of the angular velocities is continuously equal to or less than a fourth threshold value after the timing of the impact and close to the timing of the impact, as a finish period (T6 to T8 in FIG. 26).

In this way, the exercise analysis unit 414 can detect the rhythm of the swing. The exercise analysis unit 414 can specify each period (for example, a backswing period from the start of the swing to the start of the top, a downswing period from the end of the top to the impact, and a follow-through period from the impact to the end of the swing) during the swing by detecting the rhythm.

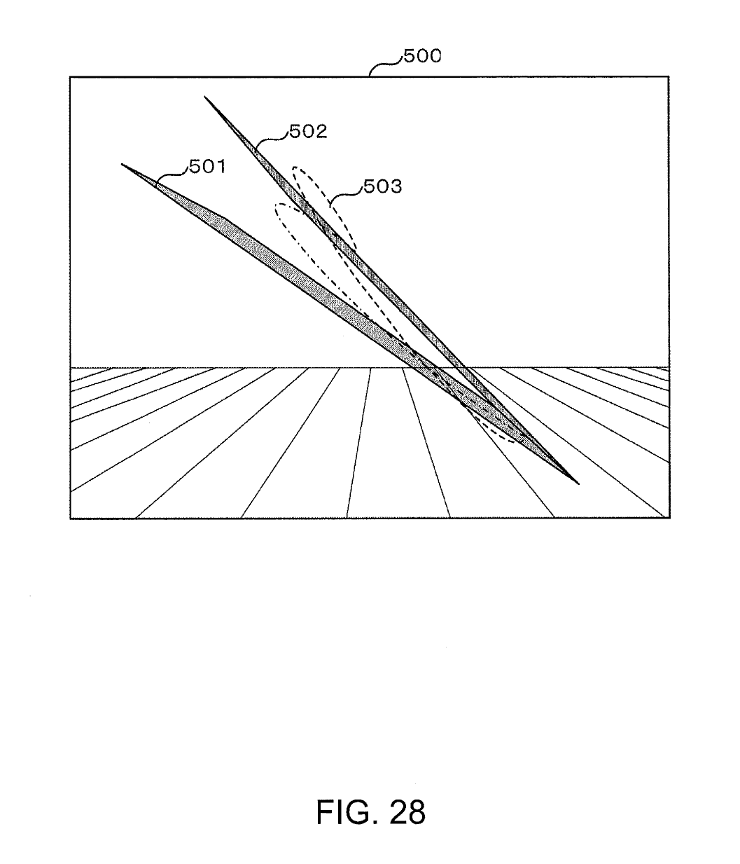

FIG. 28 is a diagram illustrating the shaft plane and the Hogan's plane projected to the YZ plane (when adjustment is not necessary). FIG. 28 illustrates an example of an image displayed when the angle of the Hogan's plane 40 specified by the second imaginary plane specifying unit 412 is not greater than the predetermined upper limit angle.

An image 500 is an example of an image displayed on the display unit 25. The image 500 includes polygon data 501 indicating the shaft plane 30, polygon data 502 indicating the Hogan's plane 40, and a curved line 503 indicating the trajectory of the golf club 3 at the time of a downswing of the user 2. In the image 500, the V zone which is a space between the polygon data 501 and the polygon data 502 can be recognized.

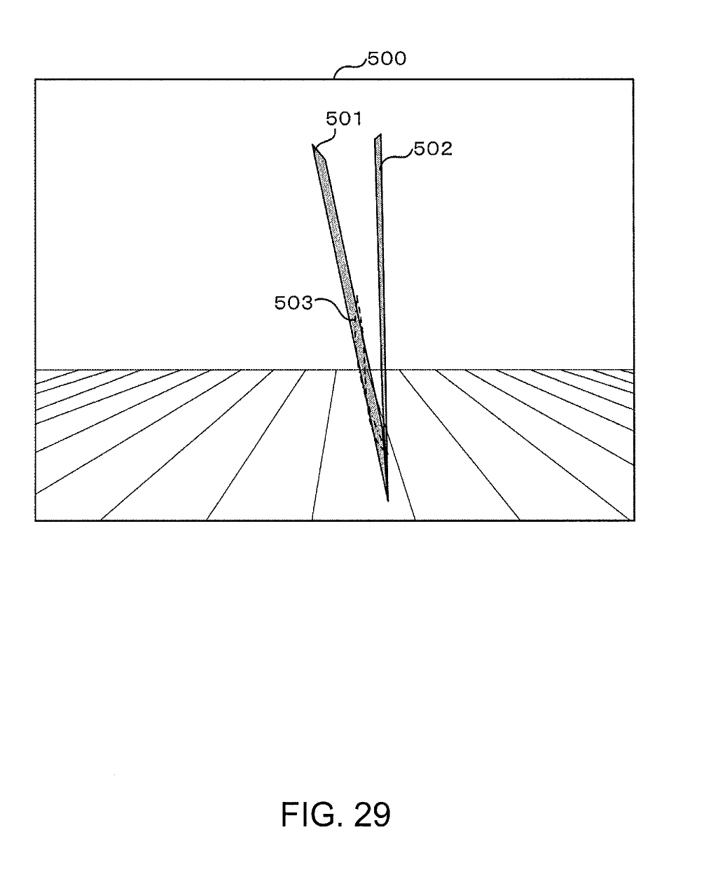

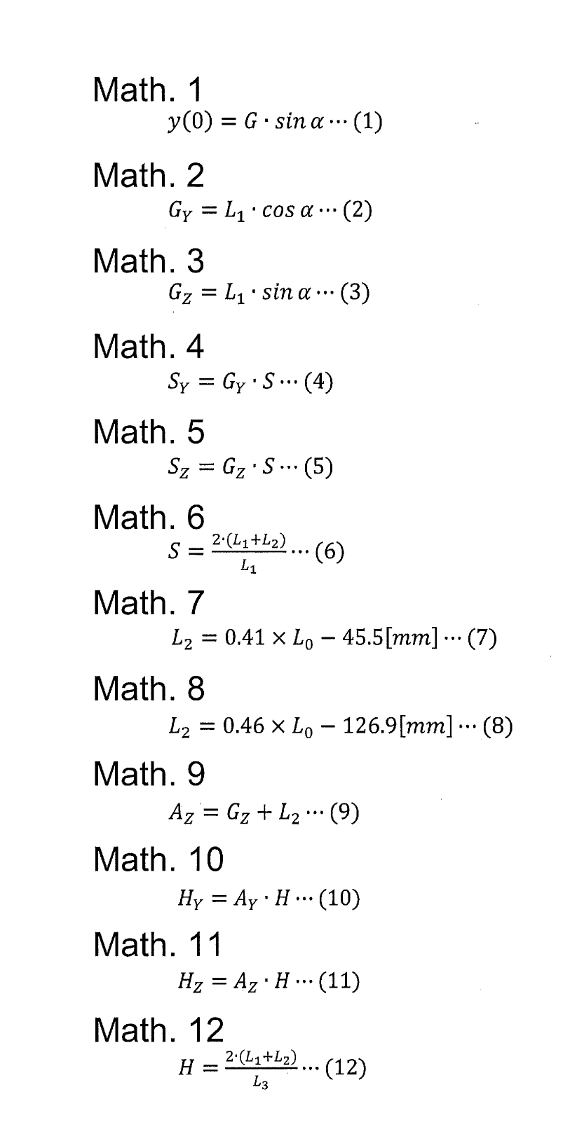

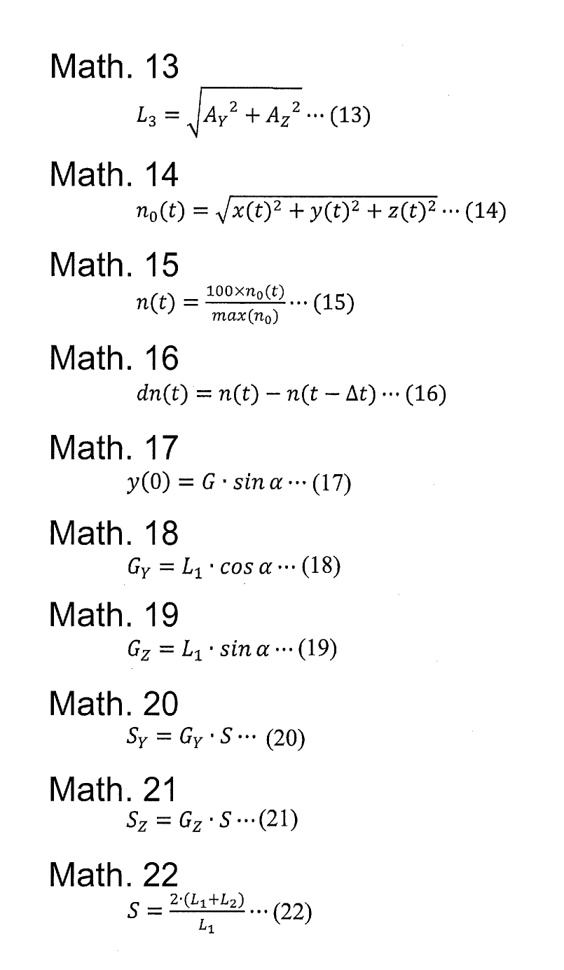

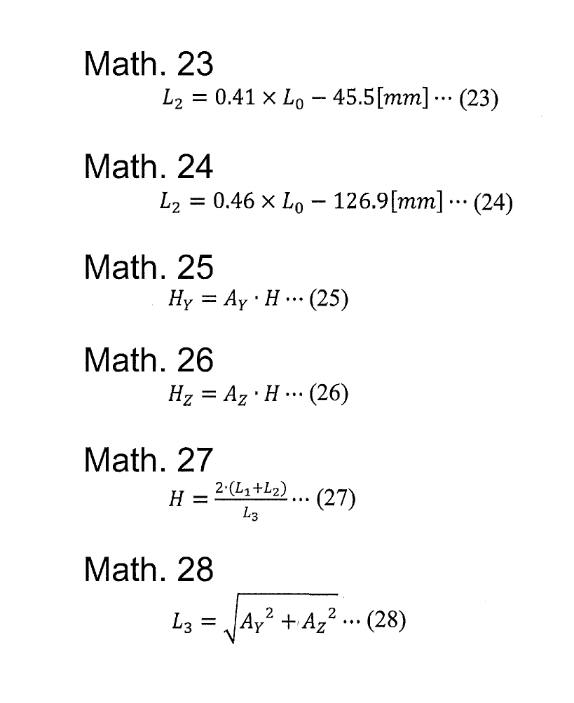

FIG. 29 is a diagram illustrating the shaft plane and the Hogan's plane projected to the YZ plane (when adjustment is performed). FIG. 29 illustrates an example of an image displayed when the angle of the Hogan's plane 40 specified by the second imaginary plane specifying unit 412 is greater than the predetermined upper limit angle.

In FIG. 29, the polygon data 502 indicating the Hogan's plane 40 is displayed at 90 degrees.

When the V zone is displayed in FIGS. 28 and 29, the V zone may not be displayed as a plane, and only the first line segment 51 (or a straight line which lies along the first line segment 51) included in the shaft plane 30 and the second line segment 53 (or a straight line which lies along the second line segment 53) included in the Hogan's plane 40 may be displayed. The images illustrated in FIGS. 28 and 29 may be 3-dimensional images of which display angles (viewpoints at which the images are viewed) can be changed through an operation of the user 2.

The embodiments of the invention have been described above. According to the embodiments, since the user can objectively recognize the address posture based on the positions and the inclinations of the shaft plane and the Hogan's plane, the size of the V zone, and the like, it is possible to evaluate the goodness and badness of a swing more simply. Since the user can recognize the positional relation between the trajectory of the golf club and the shaft plane and the Hogan's plane at the time of a swing, it is possible to evaluate the goodness and the badness of a swing more accurately than in the related art.

According to the embodiment, by imposing the restriction that the user performs address so that the major axis of the shaft of the golf club is vertical to the target line, the exercise analysis device can specify the third line segment indicating the target direction of the hitting using the measurement data of the sensor unit at the time of the address. Accordingly, the exercise analysis device can appropriately specify the shaft plane in accordance with the direction of the third line segment. According to the embodiment, since the Hogan's plane is specified by rotating the Hogan's plane by the predetermined angle θ using the shaft plane as the criterion, it is possible to appropriately specify the Hogan's plane using the measurement data of one sensor unit. According to the embodiment, when the angle of the Hogan's plane specified using the predetermined angle θ exceeds the predetermined upper limit angle, the angle of the Hogan's plane is adjusted to an angle equal to or less than the predetermined upper limit angle. Accordingly, it is possible to prevent the Hogan's plane of the position and the inclination which are rarely assumed generally from being specified, and it is possible to specify the Hogan's plane of the more appropriate position and inclination. It is possible to prevent the Hogan's plane of the position and the inclination which are rarely generally assumed from being displayed and it is possible to prevent discomfort of the user from occurring. According to the embodiment, when the angle of the Hogan's plane specified using the predetermined angle θ exceeds the predetermined upper limit angle, not only the angle of the Hogan's plane may be adjusted to an angle equal to or less than the predetermined upper limit angle, but the angle of the shaft plane may also be adjusted to be small. Accordingly, it is possible to prevent the area of the V zone from being narrowed more than when only the Hogan's plane is adjusted. According to the embodiment, since the shaft plane and the Hogan's plane are specified using the sensor unit, it is not necessary to use a large-scale device such as a camera and restriction of a place where a swing is analyzed is small.

### 2. Modification Examples

The invention is not limited to the foregoing embodiments, but can be modified in various forms within the scope of the gist of the invention.

For example, in the foregoing first embodiment, the first specifying unit 213 and the second specifying unit 214 perform the process of specifying the first line segment 51 (or the shaft plane 30) and the second line segment 53 (or the Hogan's plane 40) when the inclination (the inclination angle θ) of the golf club 3 calculated by the inclination calculation unit 211 is included in the criterion range (this process is not performed when the inclination angle θ is not included in the criterion range), but the invention is not limited thereto. For example, when it is detected that the user 2 continuously stops for a predetermined time, the first specifying unit 213 and the second specifying unit 214 perform this process irrespective of whether the inclination angle θ is included in the criterion range. The image data generation unit 216 may generate the image data including the polygon data of the shaft plane 30, the polygon data of the Hogan's plane 40, and the curved-line data indicating the trajectory of the golf club 3 so that the inclination angle θ is included in the criterion range (this image data is not generated when the inclination angle θ is not included in the criterion range).

In the foregoing first embodiment, the inclination calculation unit 211 directly calculates the inclination (the inclination angle θ) of the golf club 3 before the swing start using the measurement data of the sensor unit 10, and the determination unit 212 directly determines whether the inclination angle θ is included in the criterion range, but the invention is not limited thereto. For example, when the angle formed by the major axis direction of the golf club 3 and each detection axis of the sensor unit 10 is known, the inclination calculation unit 211 may calculate the inclination (for example, the inclination angle of one detection axis with respect to the horizontal plane (XY plane)) or the posture of the sensor unit 10 using the measurement data of the sensor unit 10 and the determination unit 212 may determine whether the inclination or the posture of the sensor unit 10 is included in the range based on the information defining the range of the inclination or the posture of the sensor unit 10 corresponding to the criterion range of the inclination angle θ of the golf club 3 to indirectly determine whether the inclination angle θ is included in the criterion range.

In the foregoing first embodiment, the second specifying unit 214 calculates the Z coordinate AZ of the predetermined position 63 between the head and the chest (for example, on the line segment connecting both shoulders to each other) of the user 2 as the sum of the Z coordinate GZ of the position 62 of the grip end and the length L2 of the arm of the user 2, as in equation (9), but another equation may be used. For example, the second specifying unit 214 may calculate the Z coordinate AZ by multiplying L2 by a coefficient K and adding GY as in “AZ=GY+K·L2”.

In the foregoing first embodiment, the second specifying unit 214 calculates the coordinates of the predetermined position 63 between the head and the chest (for example, on the line segment connecting both shoulders to each other) of the user 2 using the body information of the user 2 and specifies the second line segment 53 serving as the second axis or the Hogan's plane 40, but the invention is not limited thereto. For example, the second specifying unit 214 may specify a line segment and a plane obtained by rotating the shaft plane 30 and the first line segment 51 serving as the first axis specified by the first specifying unit 213 by a predetermined angle (for example, 30°) around the X axis, as the second line segment 53 and the Hogan's plane 40.

In the foregoing first embodiment, the processing unit 21 detects the timing (impact) at which the user 2 hits the ball using the square root of the sum of the squares expressed in equation (14) as the composite value of the triaxial angular velocities measured by the sensor unit. However, as the composite value of the triaxial angular velocities, for example, a sum of squares of the triaxial angular velocities, a sum or an average of the triaxial angular velocities, or a product of the triaxial angular velocities may be used. Instead of the composite value of the triaxial angular velocities, a composite value of the triaxial accelerations such as a sum of squares of the triaxial accelerations or a square root of this sum, a sum or an average of the triaxial accelerations, or a product of the triaxial accelerations may be used.

In the foregoing embodiments, the acceleration sensor 12 and the angular velocity sensor 14 are built and integrated in the sensor unit 10, but the acceleration sensor 12 and the angular velocity sensor 14 may not be integrated. Alternatively, the acceleration sensor 12 and the angular velocity sensor 14 may not be built in the sensor unit 10, but may be directly mounted on the golf club 3 or the user 2. In the foregoing embodiments, the sensor unit 10 and the inclination determination device 20 or the exercise analysis device 80 are separated, but may be integrated and configured to be mounted on the golf club 3 or the user 2. The sensor unit 10 may include the inclination calculation unit 211, the determination unit 212, or other constituent elements of the inclination determination device 20 or the exercise analysis device 80 along with the inertial sensor (for example, the acceleration sensor 12 or the angular velocity sensor 14) to function as the inclination determination device or the exercise analysis device according to the invention.

In the foregoing embodiments, the inclination determination system (inclination determination device) or the exercise analysis system (exercise analysis device) analyzing a golf swing has been exemplified, but the invention can be applied to an inclination determination system (inclination determination device) or an exercise analysis system (exercise analysis device) determining whether an inclination of an exercise tool before exercise start is included in a criterion range in various exercises of tennis, baseball, and the like.

In the foregoing second embodiment, the exercise analysis device 80 specifies the Hogan's plane 40 using the inclination angle θ (for example, 30°), but the inclination angle θ may be appropriately changed. For example, the second imaginary plane specifying unit 412 may change the predetermined angle θ according to the body information (the height (the length of an arm) of the user 2). For example, as the length of the arm is longer, the predetermined angle θ may be set to be larger.

The foregoing embodiments and the modification examples are merely examples and the invention is not limited thereto. For example, each embodiment and each modification example can also be appropriately combined.

The configuration of the exercise analysis system 71 illustrated in FIG. 19 is classified according to the main processing content to facilitate understanding of the configuration of the exercise analysis system 71. The invention is not limited by the method of classifying the constituent elements or the names of the constituent elements. The configuration of the exercise analysis system 71 can also be classified into more constituent elements according to processing content. One constituent element can also be classified so that more processes can be performed. The process of each constituent element may be performed by single hardware or may be performed by plural pieces of hardware. The process of each constituent element or the share of the function is not limited to the above description as long as the goals and advantages of the invention can be achieved. In the foregoing embodiments, the sensor unit 10 and the exercise analysis device 80 have been described as separated bodies, but the functions of the exercise analysis device 80 may be mounted on the sensor unit 10.

The units of the processes of the flowchart illustrated in FIG. 20 are divided according to the main processing contents to facilitate the understanding of the exercise analysis device 80. The invention is not limited by the method of dividing the units of processes or the names of the units of the processes. The processes of the exercise analysis device 80 can also be divided into more units of processes according to processing content. One unit of process can also be divided so that more processes can be included. The processing procedures of the foregoing flowcharts are not limited to the illustrated examples.

The invention includes configurations which are substantially the same as the configurations described in the embodiments (for example, configurations in which the methods and results are the same or configurations in which goals and advantages are the same). The invention includes configurations in which unessential portions of the configurations described in the embodiments are substituted. The invention includes configurations in which the same operations and advantages as the configurations described in the embodiments or configurations in which the same goals can be achieved. The invention includes configurations in which known technologies are added to the configurations described in the embodiments.

The entire disclosure of Japanese Patent Application No. 2014-258824, filed Dec. 22, 2014 and No. 2014-257258, filed Dec. 19, 2014 are expressly incorporated by reference herein.

What is claimed is:

1. An inclination determination device comprising:
an inclination calculation unit that calculates an inclination of an exercise tool before exercise start using an output signal of an inertial sensor; and
a determination unit that determines whether the inclination of the exercise tool is included within a criterion range decided based on information regarding the exercise tool and body information regarding a user.

2. The inclination determination device according to claim 1,
wherein the body information includes at least one piece of information regarding a height, a length of an arm, and a length of a leg.

3. The inclination determination device according to claim 2,
wherein the body information further includes information regarding sex.

4. The inclination determination device according to claim 1,
wherein the information regarding the exercise tool is at least one of information regarding a length of the exercise tool and information regarding a type of the exercise tool.

5. The inclination determination device according to claim 1, further comprising:
a notification unit that notifies the user of exercise start permission when the determination unit determines that an inclination of the exercise tool is included in the criterion range.

6. The inclination determination device according to claim 1, further comprising:
a first specifying unit that specifies a first axis which lies in a major axis direction of the exercise tool using the output signal of the inertial sensor when the determination unit determines that the inclination of the exercise tool is included in the criterion range.

7. The inclination determination device according to claim 6,
wherein the first specifying unit specifies the first axis using the output signal of the inertial sensor when the inclination of the exercise tool is included in the criterion range.

8. The inclination determination device according to claim 1, further comprising:
a second specifying unit that specifies a second axis which connects a blow position to a predetermined position between a head of the user to a chest of the user, using the output signal of the inertial sensor when the determination unit determines that the inclination of the exercise tool is included in the criterion range.

9. The inclination determination device according to claim 8,
wherein the second specifying unit specifies the second axis using the output signal of the inertial sensor when the inclination of the exercise tool is included in the criterion range.

10. An inclination determination system comprising:
the inclination determination device according to claim 1; and
an inertial sensor.

11. An inclination determination method comprising:
calculating an inclination of an exercise tool before exercise start using an output signal of an inertial sensor; and
determining whether the inclination of the exercise tool is included within a criterion range decided based on information regarding the exercise tool and body information regarding a user.

12. A recording medium that records a program causing a computer to perform:
calculating an inclination of an exercise tool before exercise start using an output signal of an inertial sensor; and
determining whether the inclination of the exercise tool is included within a criterion range decided based on information regarding the exercise tool and body information regarding a user.

13. An exercise analysis device comprising:
a first specifying unit that specifies a first axis which lies in a major axis direction of a shaft of an exercise tool at an address posture of a user, using an output of an inertial sensor;
a second specifying unit that specifies a second axis forming a predetermined angle with the first axis when a hitting direction is set as a rotation axis; and
an adjustment unit that adjusts an angle of the second axis when the angle of the second axis is greater than a threshold angle.

14. The exercise analysis device according to claim 13,
wherein the adjustment unit sets the angle of the second axis to an angle which is equal to or less than the threshold angle and is greater than the angle of the first axis.

15. The exercise analysis device according to claim 14,
wherein the adjustment unit sets the angle of the second axis to the threshold angle.

16. The exercise analysis device according to claim 14,
wherein the adjustment unit sets the angle of the second axis to be less than the threshold angle.

17. The exercise analysis device according to claim 14,
wherein the adjustment unit rotates the angle of the first axis an opposite side to the second axis when the angle of the second axis is greater than the threshold angle.

18. The exercise analysis device according to claim 17,
wherein the adjustment unit sets the angles of the first and second axes without changing an angle difference between the first and second axes.

19. The exercise analysis device according to claim 17,
wherein the adjustment unit sets the angle of the second axis to the threshold angle.

20. The exercise analysis device according to claim 17,
wherein the adjustment unit sets the angle of the second axis to be less than the threshold angle.

21. The exercise analysis device according to claim 13,
wherein the first specifying unit calculates an inclination angle of the shaft with respect to a horizontal plane using the output of the inertial sensor at the address posture of the user and specifies the first axis using the inclination angle and information regarding a length of the shaft.

22. The exercise analysis device according to claim 13,
wherein when the hitting direction is set as a third axis, the first specifying unit specifies a first imaginary plane including the first and third axes and the second specifying unit specifies a second imaginary plane including the second and third axes.

23. The exercise analysis device according to claim 13,
wherein the exercise tool includes a blow surface, and
wherein the hitting direction is a direction perpendicular to the blow surface at the address posture of the user.

24. The exercise analysis device according to claim 13, further comprising:
an image generation unit that generates image data including the first and second axes.

25. The exercise analysis device according to claim 24, further comprising:
an exercise analysis unit that calculates a trajectory of the exercise tool based on a swing of the user,
wherein the image generation unit generates the image data including the first axis, the second axis, and the trajectory.

26. An exercise analysis system comprising:
an inertial sensor;
a first specifying unit that specifies a first axis which lies in a major axis direction of a shaft of an exercise tool at an address posture of a user, using an output of the inertial sensor;
a second specifying unit that specifies a second axis forming a predetermined angle with the first axis when a hitting direction is set as a rotation axis; and
an adjustment unit that adjusts an angle of the second axis when the angle of the second axis is greater than a threshold angle.

27. An exercise analysis method comprising:
specifying a first axis which lies in a major axis direction of a shaft of an exercise tool at an address posture of a user, using an output of an inertial sensor;
specifying a second axis forming a predetermined angle with the first axis when a hitting direction is set as a rotation axis; and
adjusting an angle of the second axis when the angle of the second axis is greater than a threshold angle.

28. A recording medium that records a program causing a computer to perform:
specifying a first axis which lies in a major axis direction of a shaft of an exercise tool at an address posture of a user, using an output of an inertial sensor;
specifying a second axis forming a predetermined angle with the first axis when a hitting direction is set as a rotation axis; and
adjusting an angle of the second axis when the angle of the second axis is greater than a threshold angle.
